(19) United States
(12) Patent Application Publication
(10) Pub. No.: US 2019/0246749 A1
(43) Pub. Date: Aug. 15, 2019

(54) TRACK ZIPPER AND CONNECTING STRUCTURE WITH A TRACK ZIPPER

(71) Applicant: Ka Yin Yik, Hong Kong (HK)

(72) Inventors: Chi Yin Mak, Hong Kong (HK); Ka Yin Yik, Hong Kong (HK)

(21) Appl. No.: 16/358,772

(22) Filed: Mar. 20, 2019

Related U.S. Application Data
(63) Continuation of application No. 15/957,997, filed on Apr. 20, 2018.

(30) Foreign Application Priority Data
Feb. 15, 2018 (CN) 201810152491.X

(51) Int. Cl. A44B 19/26; E05D 7/10; B65D 33/25; B65D 63/10; E05D 7/00

(52) U.S. Cl. CPC A44B 19/262; E05D 7/10; B65D 2563/107; B65D 63/10; E05D 7/009; B65D 33/2591

(57) ABSTRACT

The present disclosure relates to a track zipper and a connecting structure having a track zipper. The track zipper includes a first track, a second track, and a zipper core connecting the first and second tracks. The first track and a first side of the zipper core are provided with a first slidably connecting structure. The second track and a second side of the zipper core are provided with a second slidably connecting structure. When the track zipper is in a closed position, a plurality of first and second core elements of the zipper core interlock with a plurality of first and second track elements of the first and second tracks respectively, such that the zipper core is inseparable from the first and second tracks. The track zipper is advantageous in that it can prevent foreign material from being caught by the zipper, and has a much stronger bearing capacity.

### CROSS REFERENCE TO RELATED APPLICATIONS

The present application is a continuation application of U.S. patent application Ser. No. 15/957,997 filed on Apr. 20, 2018, which claims the benefit of Chinese Patent Application No. 201810152491.X filed on Feb. 15, 2018. All of the above are hereby incorporated by reference.

### TECHNICAL FIELD

The present disclosure relates to a zipper or zipper-like device, and more specifically relates to a track zipper and a connecting structure having a track zipper.

### BACKGROUND

Zippers, known as one of the top ten inventions that make people's life more convenient, have more than 100 years of history. Existing zippers generally include two flexible tapes with two rows of teeth (metal teeth or plastic teeth), and a zipper head for pulling the two rows of teeth into interlocking position, thereby connecting the two flexible tapes together. Zippers can be used in clothing, bags, tents and other items. Through the function of the zipper head, the zipper can be zipped up or unzipped as needed. When the zipper head is moved upwards, the two rows of teeth on the two tapes are limited by the shape of the closure angle of the channel inside the zipper head. When the two rows of teeth are pushed towards each other, the teeth are interlocked and the zipper is closed. When the zipper head is pulled to the top of the zipper, the width of a top stop is greater than the width of the narrowest part of the inner cavity of the zipper head such that further movement of the zipper head is limited and the zipper head would not fall off. When the zipper head is pulled downwards, a pillar in the inner cavity of the zipper head having two surfaces at a splitting angle (dihedral angle) can separate the peaks and valleys of the teeth one by one, and the two tapes are separated. When the zipper head is pulled to the bottom of the zipper, the width of a bottom stop is greater than the width of a bottom opening of the zipper head, and the zipper head would not fall off.

Although zippers are very convenient for people's life, they are not perfect and they have certain defects. The ingenious idea of a zipper is the formation of a hook and a recess on each tooth so that the teeth can interlock one with the other. However, this is also its weakness. In fact, as long as one of the zipper teeth fails, it can lead to failure of the entire zipper. Also, if one deliberately destroys the zipper teeth by using a sharp object such as the tip of a pen, it can pierce through the teeth, thereby causing gradual separation of the two rows of teeth of the zipper. Furthermore, if two pliers are used to clamp onto the two tapes and force is applied by the two pliers, it can separate the interlocked teeth of the zipper. The separated teeth, especially the pair of teeth closest to the closing position, usually cannot be perfectly interlocked again. As a result, the zipper head cannot pass through the damaged teeth, and the entire zipper become useless. The design of zipper is also limited by its size. When the zipper head is moved upwards, adjacent teeth need to be completely interlocked, and when the zipper head is moved downwards, the zipper head needs to separate the interlocked teeth. Furthermore, the material in some parts of the zipper is very thin, and thus the load capacity of the zipper is limited.

### SUMMARY

The technical problem to be solved is to provide a track zipper that can obviate the above-mentioned defects of the existing zippers.

According to one aspect, there is provided a track zipper including a first track, a second track, a zipper core connecting the first and second tracks, a plurality of first and second core elements formed along a first and second side of the zipper core respectively and spaced apart in a lengthwise direction of the zipper core, a plurality of first and second track elements formed along the first and second tracks respectively and spaced apart in a lengthwise direction of the first and second tracks, and a plurality of first and second slots defined by the plurality of first and second track elements, the plurality of first and second slots are dimensioned to allow the plurality of first and second core elements to pass therethrough in a direction perpendicular to the lengthwise direction of the first and second tracks respectively. The plurality of first and second core elements and the plurality of first and second track elements are sized and shaped so that when the track zipper is in a closed position, the plurality of first and second core elements are interlocked with the plurality of first and second track elements respectively, and the zipper core is inseparable from the first and second tracks in the direction perpendicular to the lengthwise direction of the first and second tracks. The zipper core is slidable relative to the first and second tracks along the lengthwise direction thereof by a distance of one track element to a position where the plurality of first and second core elements are disengaged from the plurality of first and second track elements respectively, so that the zipper core is detachable from the first and second tracks in the direction perpendicular to the lengthwise direction thereof.

In one embodiment, the plurality of first and second core elements are in the form of protrusions, and the plurality of first and second track elements are in the form of recesses.

In one embodiment, the plurality of first and second core elements are in the form of recesses, and the plurality of first and second track elements are in the form of protrusions.

According to another aspect, there is provided a track zipper including a first track, a second track, a zipper core connecting the first and second tracks, a first slidably connecting structure provided on the first track and a first side of the zipper core, the zipper core being slidable relative to the first track along a lengthwise direction thereof, and the zipper core being inseparable from the first track in a direction perpendicular to the lengthwise direction of the first track, and a second slidably connecting structure provided on the second track and a second side of the zipper core, the zipper core being slidable relative to the second track along a lengthwise direction thereof, and the zipper core being inseparable from the second track in a direction perpendicular to the lengthwise direction of the second track. A front plurality of first and second zipper teeth is formed along the first and second tracks respectively and disposed at a front side of the zipper core, and a rear plurality of first and second zipper teeth is formed along the first and second tracks respectively and disposed at a rear side of the zipper core. A zipper head is formed at an upper end of the zipper core. The zipper head includes a front and rear Y-shaped channel provided on the front side and the rear side of the zipper core respectively. The front and rear Y-shaped channels are defined by a top wedge and two sidewalls. The front and rear Y-shaped channels are dimensioned to allow the front and rear plurality of first and second zipper teeth to pass through in a manner of a conventional zipper.

In one embodiment, the track zipper further includes an upper guiding portion formed at an upper portion of each sidewall, and a lower guiding portion in the form of a protrusion formed on an inner side of each sidewall at a position where the front and rear plurality of first and second zipper teeth interlock and disengage. When the zipper head together with the zipper core is pulled upwards, the lower guiding portions press the front and rear plurality of first and second zipper teeth together so that the front and rear plurality of first and second zipper teeth are interlocked with each other, thereby closing the track zipper. When the zipper head together with the zipper core is pulled downwards, the wedge and the upper guiding portions push the front and rear plurality of first and second zipper teeth apart so that the front and rear plurality of first and second zipper teeth are disengaged from each other, thereby opening the track zipper.

In one embodiment, the track zipper further includes an outwardly extending projection formed at a free end of each zipper teeth. The outwardly extending projections of one of the first and second tracks are insertable into corresponding inwardly facing slots of the other one of the first and second tracks. An outwardly extending guiding portion is formed on a front surface and a rear surface of the zipper core at a position where the front and rear plurality of first and second zipper teeth interlock and disengage. An inwardly extending guiding portion is formed on the front side and the rear side of the zipper core, and disposed above and spaced outwardly apart from the outwardly extending guiding portion. When the zipper head together with the zipper core is pulled upwards, the outwardly extending guiding portions press the front and rear plurality of first and second zipper teeth outwards, the outwardly extending projections of the front and rear plurality of first and second zipper teeth are inserted into the corresponding inwardly facing slots, and the front and rear plurality of first and second zipper teeth are interlocked with each other, thereby closing the track zipper. When the zipper head together with the zipper core is pulled downwards, the wedge pushes the front and rear plurality of first and second zipper teeth apart, the inwardly extending guiding portions press the front and rear plurality of first and second zipper teeth inwards, the outwardly extending projections of the front and rear plurality of first and second zipper teeth are released from the corresponding inwardly facing slots, and the front and rear plurality of first and second zipper teeth can be disengaged from each other, thereby opening the track zipper.

According to yet another aspect, there is provided a track zipper including a first track, a second track, a zipper core connecting the first and second tracks, a first slidably connecting structure provided on the first track and a first side of the zipper core, the zipper core being slidable relative to the first track along a lengthwise direction thereof, and the zipper core being inseparable from the first track in a direction perpendicular to the lengthwise direction of the first track, and a second slidably connecting structure provided on the second track and a second side of the zipper core, the zipper core being slidable relative to the second track along a lengthwise direction thereof, and the zipper core being inseparable from the second track in a direction perpendicular to the lengthwise direction of the second track. When the track zipper is in an open position, the first and second tracks are disposed at an angle with respect to each other, and the zipper core is located at one ends of the first and second tracks where the angle is formed. When the track zipper is in a closed position, the first and second tracks are parallel to each other, and the zipper core is slidable to a position away from the one ends of the first and second tracks, thereby closing the track zipper. The first track, the second track, and the zipper core are made of a rigid material.

In one embodiment, the first slidably connecting structure includes a first track groove formed on the first track, and a first track portion formed on the first side of the zipper core and mating with the first track groove. The first track portion of the zipper core is sheathed in the first track groove and slidable in the first track groove along an extending direction thereof, and inseparable from the first track groove in a direction perpendicular to the extending direction of the first track groove.

In one embodiment, the first slidably connecting structure includes a first track portion formed on the first track, and a first track groove formed on the first side of the zipper core and mating with the first track portion. The first track groove of the zipper core is sheathed on the first track portion, and the first track groove is slidable on the first track portion along an extending direction thereof and inseparable from the first track portion in a direction perpendicular to the extending direction of the first track portion.

In one embodiment, the second slidably connecting structure includes a second track groove formed on the second track, and a second track portion formed on the second side of the zipper core and mating with the second track groove. The second track portion of the zipper core is sheathed in the second track groove and slidable in the second track groove along an extending direction thereof, and inseparable from the second track groove in a direction perpendicular to the extending direction of the second track groove.

In one embodiment, the second slidably connecting structure includes a second track portion formed on the second track, and a second track groove formed on the second side of the zipper core and mating with the second track portion. The second track groove of the zipper core is sheathed on the second track portion, the second track groove being slidable on the second track portion along an extending direction thereof, and inseparable from the second track portion in a direction perpendicular to the extending direction of the second track portion.

According to a further aspect, there is provided a connecting structure including a first rigid object, a second rigid object hingedly connected to the first rigid object by a hinge, and a first and second track zipper, each being described above, for connecting the first and second rigid objects. One of the first and second tracks of the first track zipper and one of the first and second tracks of the second track zipper are respectively attached along two side portions of the first rigid object adjacent to the hinge, and another one of the first and second tracks of the first track zipper and another one of the first and second tracks of the second track zipper are respectively attached along two side portions of the second rigid object adjacent to the hinge. When the first and second track zippers are in an open position, the first and second tracks of each track zipper are disposed at an angle with respect to each other. The zipper cores are located at one ends of the first and second tracks of the first and second track zippers respectively along a zipper core axis passing through the zipper cores and coincident with a hinge axis of the hinge. The zipper cores are slidable together along the first and second tracks of the first and second track zippers respectively in a direction away from the hinge, thereby closing the first and second track zippers.

In one embodiment, the connecting structure further include a cross bar having a first end connected to the first zipper core of the first track zipper, and a second end connected to the second zipper core of the second track zipper.

In one embodiment, the first rigid object is a door and the second rigid object is a door frame. The door is closed when the first and second track zippers are in the closed position.

In one embodiment, the first rigid object is a cover and the second rigid object is a frame for the cover. The cover is closed when the first and second track zippers are in the closed position.

In one embodiment, first rigid object is a first panel of a piece of furniture and the second rigid object is a second panel of the piece of furniture. The first and second panels are secured together when the first and second track zippers are in the closed position.

In one embodiment, the first rigid object is a seat of a foldable chair and the second rigid object is a pair of crossed legs of the foldable chair. The seat and the pair of crossed legs are secured together when the first and second track zippers are in the closed position.

In one embodiment, the first and second rigid objects are a casing of a lock. The casing is folded up to secure a T-shaped object in a T-shaped trough in the casing when the first and second track zippers are in the closed position.

In one embodiment, the first and second rigid objects are a casing of a hose clamp or a reusable cable tie. The casing is folded up to secure therein a serrated band attached to the casing when the first and second track zippers are in the closed position.

In one embodiment, the first and second rigid objects are parts of a device for adjusting opening angle of a window.

The track zipper of the present disclosure has the following beneficial effects. Since the track zipper of the present disclosure is provided with a zipper core slidable between a first track and a second track, and connecting the first track and the second track together, it can overcome the disadvantage of the existing zippers which can have foreign material easily caught by the teeth of the zipper and can lead to failure of the entire zipper due to damage of a few teeth of the zipper. In addition, the track zipper of the present disclosure has a much stronger bearing capacity, and therefore it cannot be easily damaged or pulled apart even by a strong force.

### BRIEF DESCRIPTION OF THE DRAWINGS

The present disclosure will be further explained in conjunction with embodiments and the following drawings in which:

FIG. 1a is a schematic diagram of a zipper core according to an embodiment of the track zipper of the present disclosure;

FIG. 1b is a schematic cutaway diagram of the zipper core as shown in FIG. 1a;

FIG. 1c is a schematic diagram of the first and second tracks according to an embodiment of the track zipper of the present disclosure;

FIG. 1d is a schematic diagram of the zipper core coupling with the first track and the second track according to an embodiment of the track zipper of the present disclosure;

FIG. 1e is a cross-sectional view of the track zipper shown in FIG. 1d;

FIG. 1f is another schematic diagram in which the zipper core is coupled with the first track and the second track according to an embodiment of the track zipper of the present disclosure;

FIG. 1g is a cross-sectional view of the track zipper shown in FIG. 1f;

FIG. 1h is a top view of an embodiment of the track zipper of the present disclosure;

FIG. 1i is a cross-sectional view of the A-A plane in FIG. 1h;

FIG. 1j is a schematic diagram of a collapsible zipper core of the track zipper of the present disclosure in a collapsed position;

FIG. 1k is a schematic diagram of the collapsible zipper core of the track zipper of the present disclosure in an expanded position;

FIG. 2a is a schematic diagram of the zipper core according to another embodiment of the track zipper of the present disclosure;

FIG. 2b is a schematic cutaway diagram of the zipper core as shown in FIG. 2a;

FIG. 2c is a schematic diagram of the first and second tracks according to another embodiment of the track zipper of the present disclosure;

FIG. 2d is a schematic diagram in which the zipper core is coupled with the first track and the second track according to another embodiment of the track zipper of the present disclosure;

FIG. 2e is a front schematic diagram of another embodiment of the track zipper of the present disclosure;

FIG. 2f is a cross-sectional view at the A-A plane in FIG. 2e;

FIG. 2g is a cross-sectional view at the B-B plane in FIG. 2e;

FIG. 2h is a cross-sectional view at the C-C plane in FIG. 2e;

FIG. 2i is a cross-sectional view at the D-D plane in FIG. 2e;

FIG. 2j is a cross-sectional view at the E-E plane in FIG. 2e;

FIG. 3a is a schematic diagram of another embodiment of the track zipper of the present disclosure;

FIG. 3b is a schematic diagram of another view of the track zipper as shown in FIG. 3a;

FIG. 3c is a schematic diagram of the track zipper shown in FIG. 3a;

FIG. 3d is another schematic diagram of the track zipper shown in FIG. 3a;

FIG. 3e is a partial enlarged diagram of FIG. 3d;

FIG. 3f is a schematic diagram of the rolling up mode of the zipper core in the track zipper of the present disclosure;

FIG. 3g is a schematic diagram of another rolling up mode of the zipper core in the track zipper of the present disclosure;

FIG. 3h is a schematic diagram of another structure of the track zipper of the present disclosure;

FIG. 4a is a schematic diagram of another embodiment of the track zipper of the present disclosure;

FIG. 4b is a schematic diagram of another view of the track zipper as shown in FIG. 4a;

FIG. 4c is a schematic diagram of the track zipper shown in FIG. 4a;

FIG. 4d is a schematic diagram of another view of the track zipper as shown in FIG. 4a;

FIG. 4e is a schematic diagram of the rolling up mode of the zipper core in the track zipper of the present disclosure;

FIG. 4f is a schematic diagram of another rolling up mode of the zipper core in the track zipper of the present disclosure;

FIG. 4g is a schematic diagram of another structure of the track zipper of the present disclosure;

FIG. 5a is a schematic diagram of another embodiment of the track zipper of the present disclosure;

FIG. 5b is a schematic diagram of another view of the track zipper as shown in FIG. 5a;

FIG. 5c is a schematic diagram of a partially opened track zipper of FIG. 5a;

FIG. 5d is a schematic diagram of another view of the partially opened track zipper of FIG. 5a;

FIG. 5e is a schematic diagram of a fully opened position of the track zipper of FIG. 5a;

FIG. 5f is a schematic diagram of another view of the fully opened track zipper of FIG. 5a;

FIG. 6a is a schematic diagram of another embodiment of the track zipper of the present disclosure;

FIG. 6b is a schematic diagram of a partially opened track zipper of FIG. 6a;

FIG. 6c is a schematic diagram of a fully opened track zipper of FIG. 6a;

FIG. 7a is a schematic diagram of another embodiment of the track zipper of the present disclosure;

FIG. 7b is a schematic diagram of a partially opened track zipper of FIG. 7a;

FIG. 7c is a schematic diagram of a fully opened track zipper of FIG. 7a;

FIG. 8a is a schematic diagram of another embodiment of the track zipper of the present disclosure;

FIG. 8b is a schematic diagram of an opened track zipper of FIG. 8a;

FIG. 9a is a schematic diagram of another embodiment of the track zipper of the present disclosure;

FIG. 9b is a schematic diagram of an opened track zipper of FIG. 9a;

FIG. 10a is a schematic diagram of another embodiment of the track zipper of the present disclosure;

FIG. 10b is a schematic diagram of an opened track zipper of FIG. 10a;

FIG. 11a is a schematic diagram of another embodiment of the track zipper of the present disclosure;

FIG. 11b is a schematic diagram of an opened track zipper of FIG. 11a;

FIG. 12 is a schematic diagram of the car windshield with the track zipper of the present disclosure;

FIG. 13 is a schematic diagram of a window with the track zipper of the present disclosure;

FIG. 14 is a schematic diagram of a space suit with the track zipper of the present disclosure;

FIG. 15 is a schematic diagram of a sail with the track zipper of the present disclosure;

FIG. 16a is a schematic diagram of another embodiment of the track zipper of the present disclosure;

FIG. 16b is a front view of the track zipper shown in FIG. 16a;

FIG. 16c is a cross-sectional view at the A-A plane in FIG. 16b;

FIG. 16d is a schematic diagram of the track zipper shown in FIG. 16a in a closed position;

FIG. 16e is a front view of the track zipper shown in FIG. 16d;

FIG. 16f is cross-sectional view at @-@ in FIG. 16e;

FIG. 17a is a schematic diagram of another embodiment of the track zipper of the present disclosure in an opened position;

FIG. 17b is a schematic diagram of the track zipper shown in FIG. 17a in a closed position;

FIG. 18a is a schematic diagram of another embodiment of the track zipper of the present disclosure in an opened position;

FIG. 18b is a schematic diagram of the track zipper shown in FIG. 18a in a closed position;

FIG. 19a is a schematic diagram of a window frame with the track zipper of the present disclosure;

FIG. 19b is a cross-sectional view at B-B in FIG. 19a;

FIG. 19c is a cross-sectional view at A-A in FIG. 19a;

FIG. 20 is a schematic diagram of the track zipper of the present disclosure used for connecting a frame and a base plate;

FIGS. 21a-21d are schematic diagrams of the track zipper of the present disclosure used for connecting a door or a cover;

FIGS. 22a-22c are schematic diagrams of the track zipper of the present disclosure for use in a door-like structure;

FIGS. 23a-23b are schematic diagrams of the track zipper of the present disclosure used for connecting a movable part and a stationary part;

FIGS. 24a-24c are schematic diagrams of the track zipper of the present disclosure for use in an automatic hook;

FIG. 25 is a schematic diagram of the track zipper of the present disclosure for use in a foldable chair;

FIG. 26 is a schematic diagram of the track zipper of the present disclosure for use in a hose clamp;

FIG. 27 is a schematic diagram of the track zipper of the present disclosure for use in a lock; and

FIGS. 28a-28b are schematic diagrams of the track zipper of the present disclosure for use in a drawing frame or a mirror frame.

### DETAILED DESCRIPTION

In order to have a clearer understanding of the technical characteristics, purposes and effects of the present disclosure, specific embodiments of the present disclosure are described in detail with the drawings.

The following is a detailed description of the track zipper of the present disclosure and some embodiments of the connecting structure with the track zipper, embodiments of which are shown in the drawings where the same or similar markings throughout the drawings represent the same or similar components, or components that have the same or similar functions.

In the description of the track zipper and the connecting structure with the track zipper of the present disclosure, it is understood that the orientation or position of the terms such as “front”, “rear”, “top”, “bottom”, “upper end”, “lower end”, “upper portion”, “lower portion”, etc., is based on the position or direction indicated in the drawings. They are used to describe the present disclosure and simplify the description only. They are not used to indicate or imply that the device or element must have a specific orientation, or it is constructed and operated in a particular direction. It is understood that these terms are not a restriction on the present disclosure. In addition, the term “first” and “second” are used only for descriptive purposes and cannot be understood as an indication or implication of its relative importance.

The track-type zipper provided by the present disclosure may include a first track, a second track, and a zipper core connecting the first and second tracks. The length of the zipper core may be equal to or less than the length of the first track and the second track. A first slidably connecting structure may be provided on the first track and a first side of the zipper core. The zipper core can be slidable relative to the first track along a lengthwise direction thereof through the first slidably connecting structure. The zipper core is inseparable from the first track in a direction perpendicular to the lengthwise direction of the first track. A second slidably connecting structure may be provided on the second track and a second side of the zipper core. The zipper core can be slidable relative to the second track along a lengthwise direction thereof through the second slidably connecting structure. The zipper core is inseparable from the second track in a direction perpendicular to the lengthwise direction of the second track. When the track zipper is in a closed position, the zipper core is provided between the first and second tracks, and connects the first and second tracks together. When the track zipper is in an open position, the zipper core can cooperate with the first track, thus attaching to the first track, or the zipper core can cooperate with the second track, thus attaching to the second track. Of course, the zipper core can also be rolled up. The first slidably connecting structure and the second slidably connecting structure, in general, can be summed up as mating track portion and track groove. The track portion can slide in the track groove along the lengthwise direction of the track groove, but the track portion cannot be separated from the track groove in the direction perpendicular to the lengthwise direction of the track groove, so that when the track zipper is closed, the zipper core can connect the first and second tracks together. When the track zipper is opened, the zipper core may be attached to the first track or the second track, and the zipper core can be rolled up.

In the track zipper of the present disclosure, the first slidably connecting structure may include a first track groove formed on the first track, and a first track portion formed on the first side of the zipper core and mating with the first track groove. The first track portion can be slidable in the first track groove along an extending direction thereof, and the first track portion is inseparable from the first track groove in a direction perpendicular to the extending direction of the first track groove. Alternatively, the first slidably connecting structure may include a first track portion formed on the first track, and a first track groove formed on the first side of the zipper core and mating with the first track portion. The first track groove of the zipper core may be sheathed on the first track portion. The first track groove can be slidable on the first track portion along an extending direction thereof, and the first track groove is inseparable from the first track portion in a direction perpendicular to the extending direction of the first track portion.

In the track zipper of the present disclosure, the second slidably connecting structure may include a second track groove formed on the second track, and a second track portion formed on the second side of the zipper core and mating with the second track groove. The second track portion can be slidable in the second track groove along an extending direction thereof, and the second track portion is inseparable from the second track groove in a direction perpendicular to the extending direction of the second track groove. Alternatively, the second slidably connecting structure may include a second track portion formed on the second track, and a second track groove formed on the second side of the zipper core and mating with the second track portion. The second track groove of the zipper core may be sheathed on the second track portion. The second track groove can be slidable on the second track portion along an extending direction thereof, and the second track groove is inseparable from the second track portion in a direction perpendicular to the extending direction of the second track portion.

Since the track zipper of the present disclosure is provided with a zipper core slidable between a first track and a second track, and connecting the first track and the second track together, it can overcome the disadvantage of the existing zippers which can have foreign material easily caught between the teeth of the zipper and can lead to failure of the entire zipper due to damage of a few teeth of the zipper. In addition, the track zipper of the present disclosure has a much stronger bearing capacity, and therefore it cannot be easily damaged or pulled apart even by a strong force.

In general, the structure of the track zipper of the present disclosure is introduced, and the implementation of the track zipper of the present disclosure is illustrated in the following embodiments.

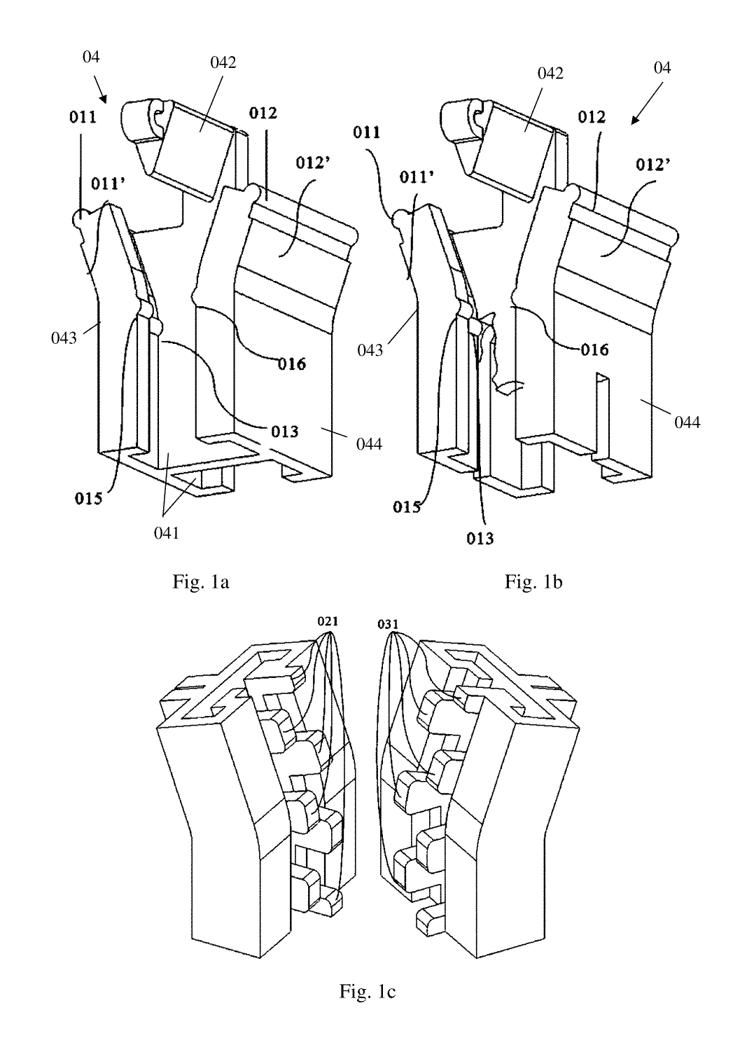

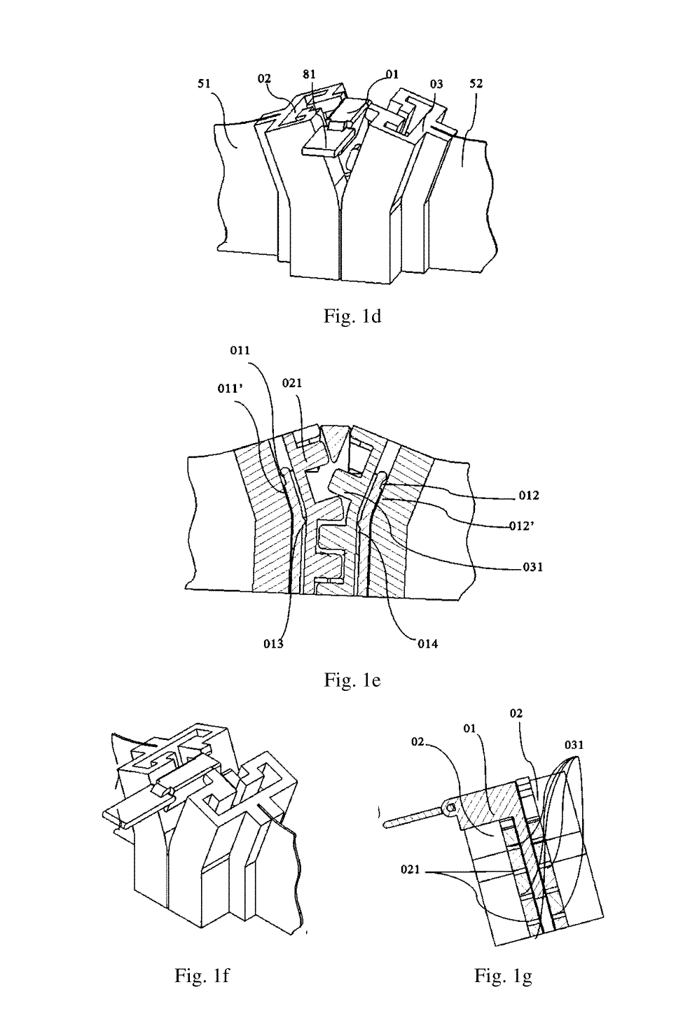

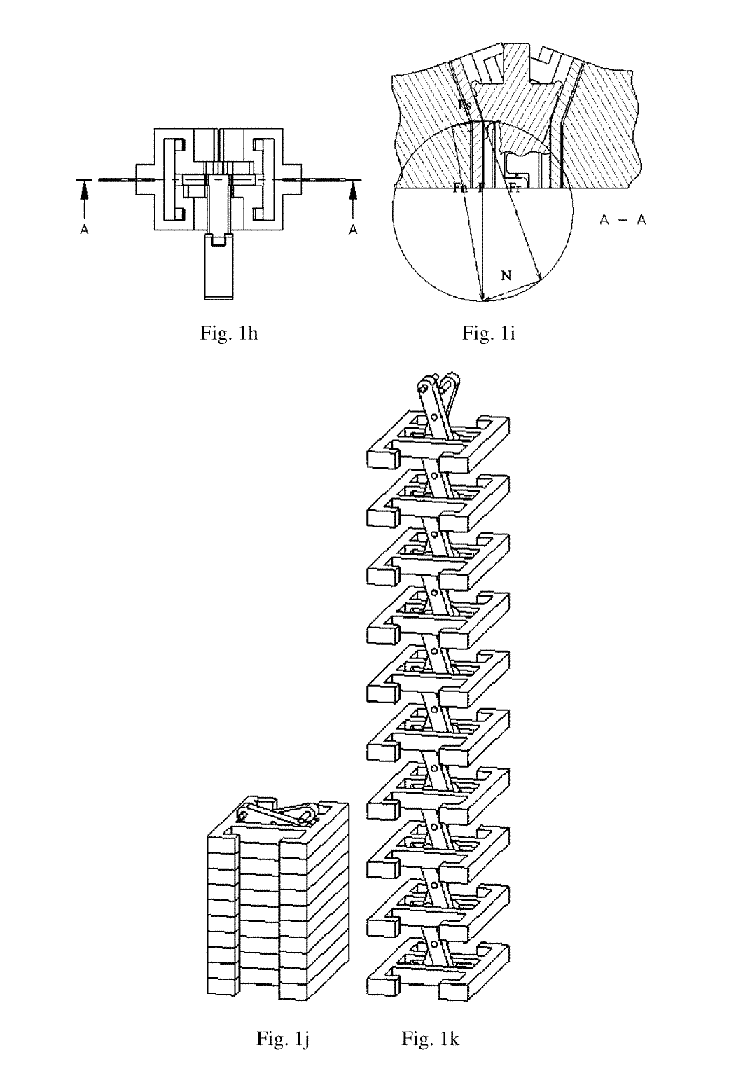

FIGS. 1a to 1i are schematic diagrams of an embodiment of the track zipper of the present disclosure. In this embodiment, the track zipper may include a first track 02 and a second track 03. The first track 02 may be connected to a first material 51, and the second track 03 may be connected to a second material 52. A zipper core 01 may be used to connect the first track 02 and the second track 03. A head portion of the zipper core 01 may be provided with a handle 81. The head portion of the zipper core 01 may also be provided with guiding portions 011 and 011′, as well as guiding portions 012 and 012′. The guiding portions 011 and 011′ can be two different designs of the guiding portion of the same zipper core. The guiding portions 012 and 012′ are also the same. The only difference is that the guiding portions 011′ and 012′ do not have extra avoiding space while the guiding portions 011 and 012 are provided with extra avoiding space. Furthermore, their cylindrical portions, including 013 to 016, can be replaced with wheels or bearings. When the zipper core 01 is pulled downwards, the top ends, the cylindrical portions, or the bearings of the guiding portions 011 or 011′ and 012 or 012′ can be used to push the first track 02 and the second track 03 open. When the zipper core 01 is pulled upwards, the cylindrical portions or the bearings of the guiding portions 013 to 016 can be used to squeeze the first track 02 and the second track 03 towards the zipper core 01. As with the traditional zipper, when the zipper core 01 is pulled up and down, zipper teeth 021 and 031 are also closed or opened. As can be seen from the cross-sectional view, the zipper teeth 021 and 031 are not engaged with each other. They are located between the zipper core 01 and the first/second tracks 02, 03. To separate the first track 02 and the second track 03, they must be expanded in order to separate from the zipper core 01. The first track 02 can prevent the zipper tooth 031 from moving outwards, thus limiting the expansion of the second track 03. Similarly, the second track 03 can prevent the zipper teeth 021 from moving outwards, thus limiting the expansion of the first track 02. It is understood that even without the zipper teeth 021 and 031, the first track 02 and the second track 03 are difficult to be separated. Hence, the zipper teeth 021 and 031 may not be required. It is based on the need in order to determine whether it is required to include the zipper teeth 021 and 031.

It can be seen that the embodiment in FIGS. 1a to 1i is a combination of track zipper and zipper. The track zipper may include the first track 02, the second track 03, and the zipper core 01 connecting the first and second tracks 02, 03. A first slidably connecting structure may be provided on the first track 02 and a first side of the zipper core 01. The zipper core 01 can be slidable relative to the first track 02 along a lengthwise direction thereof, and the zipper core 01 can be inseparable from the first track 02 in a direction perpendicular to the lengthwise direction of the first track. A second slidably connecting structure may be provided on the second track 03 and a second side of the zipper core 01. The zipper core 01 can be slidable relative to the second track 03 along a lengthwise direction thereof, and the zipper core 01 can be inseparable from the second track 02 in a direction perpendicular to the lengthwise direction of the second track.

A front plurality of first and second zipper teeth 021, 031 may be formed along the first and second tracks 02, 03 respectively and disposed at a front side of the zipper core 01. In addition, a rear plurality of first and second zipper teeth 021, 031 may be formed along the first and second tracks 02, 03 respectively and disposed at a rear side of the zipper core 01.

A zipper head 04 may be formed at an upper end of the zipper core 01. The zipper head 04 may include a front and rear Y-shaped channel 041 provided on the front side and the rear side of the zipper core 01 respectively. The front and rear Y-shaped channels 041 may be defined by a top wedge 042 and two sidewalls 043, 044. The front and rear Y-shaped channels 041 can be dimensioned to allow the front and rear plurality of first and second zipper teeth 021, 031 to pass through in a manner of a conventional zipper.

In the present embodiment, the track zipper may further include at least one upper guiding portion 011, 011′ formed at an upper portion of each sidewall 043, 044, and at least one lower guiding portion 013-016 in the form of protrusions formed on an inner side of each sidewall 043, 044 at a position where the front and rear plurality of first and second zipper teeth 021, 031 interlock and disengage.

When the zipper head 04 together with the zipper core 01 is pulled upwards, the lower guiding portions 013-016 press the front and rear plurality of first and second zipper teeth 021, 031 together so that the front and rear plurality of first and second zipper teeth 021, 031 can be interlocked with each other, thereby closing the track zipper.

When the zipper head 04 together with the zipper core 01 is pulled downwards, the wedge 042 and the upper guiding portions 011, 011′, 012, 012′ push the front and rear plurality of first and second zipper teeth 021, 031 apart so that the front and rear plurality of first and second zipper teeth 021, 031 can be disengaged from each other, thereby opening the track zipper.

The zipper head 04 may be integrally formed with the zipper core 01 and form a long zipper head. It can guide the zipper teeth 021, 031 to interlock with each other. At the same time, because it is long, it can keep the interlocked zipper teeth 021, 031 inseparable from each other until the zipper is unzipped.

FIG. 1i is a force analysis diagram of the head portion of the zipper core 01 of the track zipper, wherein F is the diameter of the circle. Since Fn and N are perpendicular to Fs and Fr respectively, the figure is completed by using only a few lines. F is the force that is applied to pull the handle. Fs is the force that is applied to push the first and second tracks open. It is most directly related to the mechanical property of the material of the first and second tracks. Fr is the frictional force of the zipper core when it moves between the first and second tracks. Its inclined angle is the same as the inclined angle of the zipper core. That is, changing the inclined angle of the zipper core can change the frictional force. Of course, it can greatly improve by the addition of bearings. Stress analysis will not be discussed here in detail. One can pay attention to F, Fs and Fr only. The zipper core slides in the first and second tracks simultaneously. Thus, although only the left side is shown in the figure, the right side is a mirror image of the left side. Thus, the total force to push the first and second tracks open=2Fs. The frictional force generated between the zipper core and the first and second tracks=2Fr.

FIGS. 1j and 1k are schematic diagrams of a collapsible zipper core, wherein FIG. 1j is a schematic diagram of the zipper core in a collapsed position, and FIG. 1k is a schematic diagram of the zipper core in an expanded position.

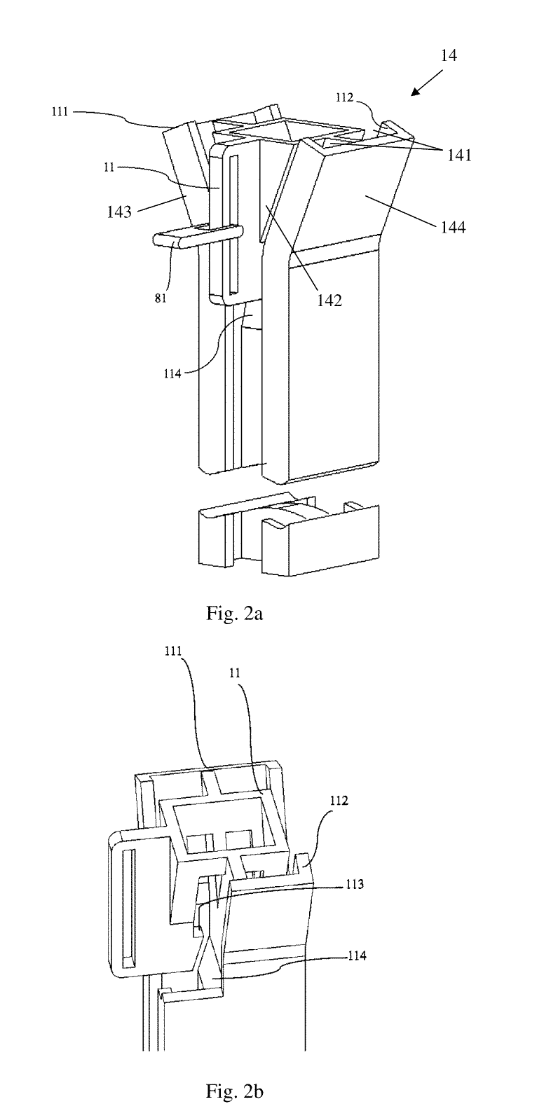

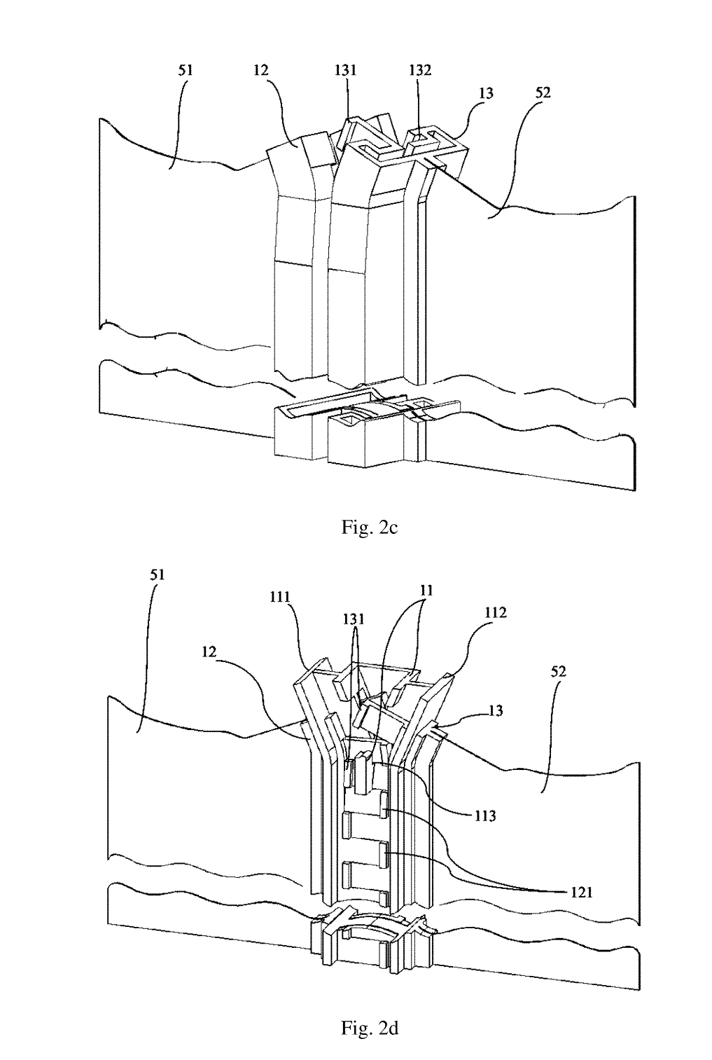

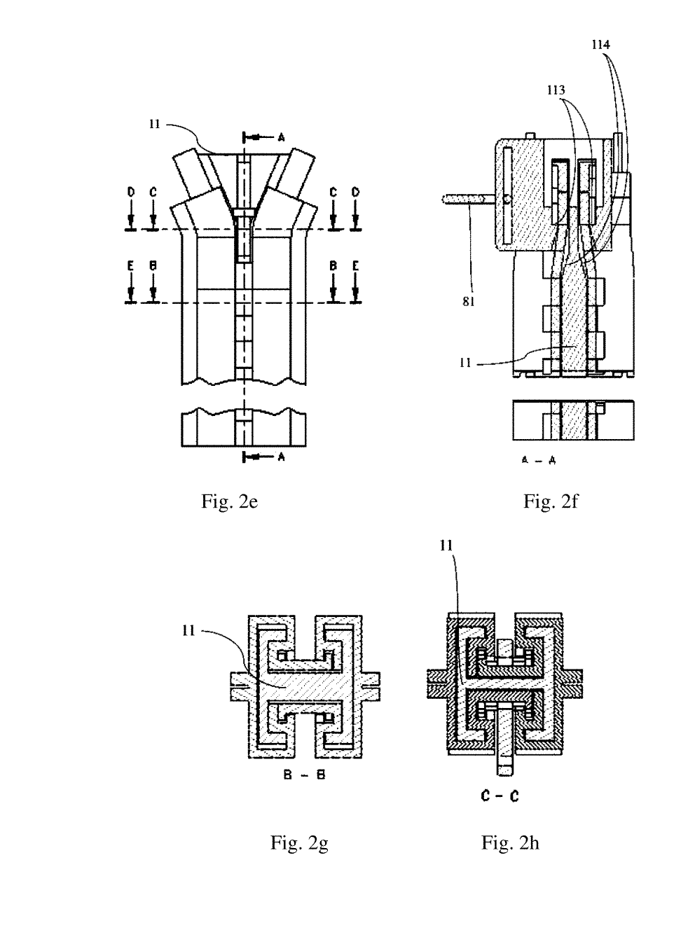

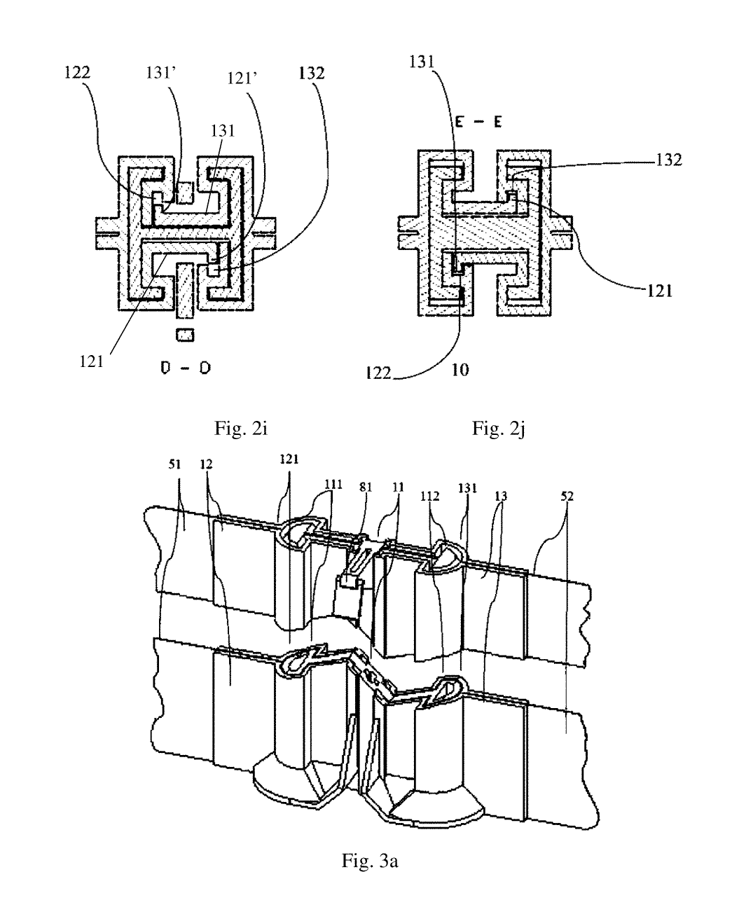

FIGS. 2a to 2j are schematic diagrams of another embodiment of the track zipper of the present disclosure. In this embodiment, the track zipper may include a first track 12, a second track 13, and a zipper core 11 connecting the first track 12 and the second track 13. The first track 12 and a first side of the zipper core 11 may be provided with a first slidably connecting structure. The first slidably connecting structure can allow the zipper core to slide relative to the first track along a lengthwise direction of the first track, and thus making the zipper core inseparable from the first track in a direction perpendicular to the first track. The second track 13 and a second side of the zipper core 11 may be provided with a second slidably connecting structure. The second slidably connecting structure can allow the zipper core to slide relative to the second track along a lengthwise direction of the second track, and thus making the zipper core inseparable from the second track in a direction perpendicular to the second track. Specifically, in this embodiment, the first sliding connecting structure may include a first track portion 111 formed on the first side of the zipper core 11 and a first track groove 121 formed on the first track 12. The first track portion 111 can slide in the first track groove 121, but cannot be separated from the first track groove 121 in the direction perpendicular to the first track 12. The second slidably connecting structure may include a second track portion 112 formed on the second side of the zipper core 11, and a second track groove 131 formed on the second track 13. The second track portion 112 can slide in the second track groove 131, but cannot be separated from the second track groove 131 in the direction perpendicular to the second track 13. The first track 12 and first material 51 may be permanently connected by mechanical means and/or chemical substance and/or piercing (e.g., piercing using its own material, or using external materials such as sewing, rivets, etc). The second track 13 and second material 52 may also be permanently connected by mechanical means and/or chemical substance and/or piercing (e.g., piercing using its own material, or using external materials such as sewing, rivets, etc). A handle 81 may be provided on a head portion of the zipper core 11. The handle 81 can be flipped up and down. The first and second tracks may be made of metal or thermoplastic materials, such as acrylonitrile-butadiene-styrene copolymer, polycarbonate, polyoxymethylene resin, polyamide resin, etc.

Referring to FIG. 2a, the function of the Y-shaped guiding portion of the zipper core 11 with its head portion diverging outwards is similar to a traditional zipper, i.e. to open and close the track zipper. FIG. 2b is a cutaway view of the zipper core 11 which shows a guiding portion 113 for pressing zipper teeth inwards, and a guiding portion 114 for pressing zipper teeth outwards. In FIG. 2d, portions of the zipper core 11, the first track 12 and the second track 13 are cut away to reveal alternating zipper teeth 121 and 131. FIGS. 2e to 2j show some cross-sectional views of the track zipper. It can be seen that the zipper core 11 forces the zipper teeth 121 and 131 into respective recesses 132 and 122 between the zipper teeth. In a narrow, upper portion of the guiding portion 114 of the zipper core 11, the zipper teeth 121 and 131 are pressed by the guiding portion 114, and are not able to enter the respective recesses 132 and 122 between the zipper teeth.

It can be seen that the embodiment in FIGS. 2a to 2j is also a combination of track zipper and zipper. As shown in FIGS. 2a to 2d, the track zipper may include a front plurality of first and second zipper teeth 121, 131 formed along the first and second tracks 12, 13 respectively and disposed at a front side of the zipper core 11, and a rear plurality of first and second zipper teeth 121, 131 formed along the first and second tracks 12, 13 respectively and disposed at a rear side of the zipper core 11. A zipper head 14 may be formed at an upper end of the zipper core 11. The zipper head 14 may include a front and rear Y-shaped channel 141 provided on the front side and the rear side of the zipper core 11 respectively. The front and rear Y-shaped channels 141 can be defined by a top wedge 142 and two sidewalls 143, 144. The front and rear Y-shaped channels 141 may be dimensioned to allow the front and rear plurality of first and second zipper teeth 121, 131 to pass through in a manner of a conventional zipper.

In the present embodiment, as illustrated in FIG. 2i, the track zipper may further include an outwardly extending projection 121′, 131′ formed at a free end of each zipper teeth 121, 131. The outwardly extending projections 121′, 131′ of one of the first and second tracks 12, 13 can be insertable into corresponding inwardly facing slots 122, 132 of the other one of the first and second tracks 12, 13.

As best illustrated in FIG. 2b, an outwardly extending guiding portion 114 may be formed on a front surface and a rear surface of the zipper core 11 at a position where the front and rear plurality of first and second zipper teeth 121, 131 interlock and disengage. An inwardly extending guiding portion 113 may be formed on the front side and the rear side of the zipper core 11, and disposed above and spaced outwardly apart from the outwardly extending guiding portion 114.

When the zipper head 14 together with the zipper core 11 is pulled upwards, the outwardly extending guiding portions 114 press the front and rear plurality of first and second zipper teeth 121, 131 outwards, thereby inserting the outwardly extending projections 121′, 131′ of the front and rear plurality of first and second zipper teeth 121, 131 into the corresponding inwardly facing slots 122, 132, and the front and rear plurality of first and second zipper teeth 121, 131 can be interlocked with each other, thereby closing the track zipper.

When the zipper head 14 together with the zipper core 11 is pulled downwards, the wedge 142 pushes the front and rear plurality of first and second zipper teeth 121, 131 apart, and the inwardly extending guiding portions 113 press the front and rear plurality of first and second zipper teeth 121, 131 inwards, thereby releasing the outwardly extending projections 121′, 131′ of the front and rear plurality of first and second zipper teeth 121, 131 from the corresponding inwardly facing slots 122, 132, and the front and rear plurality of first and second zipper teeth 121, 131 can be disengaged from each other, thereby opening the track zipper.

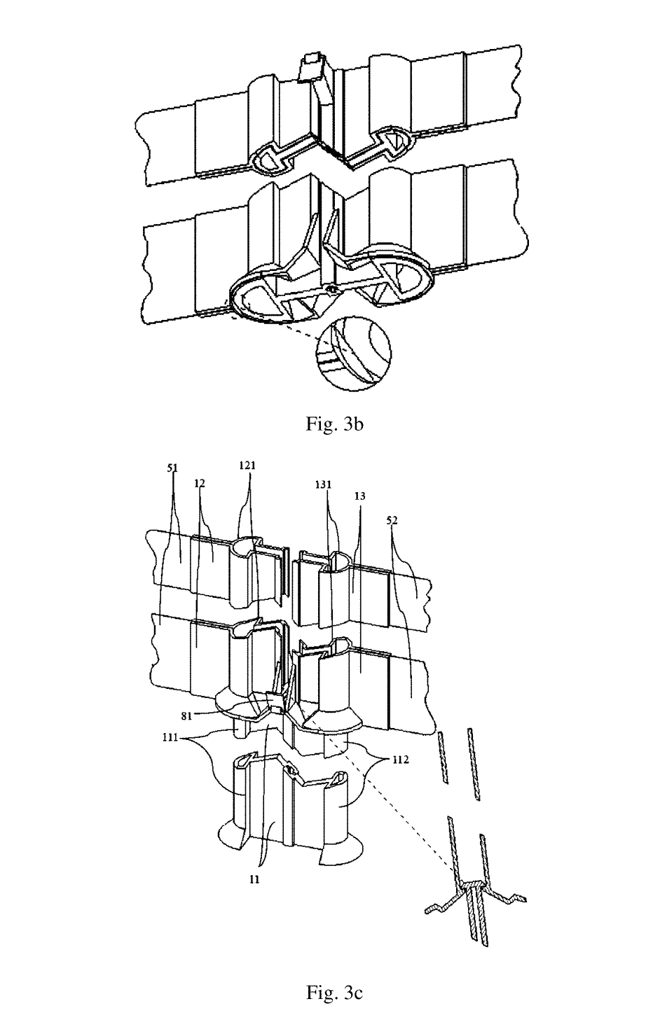

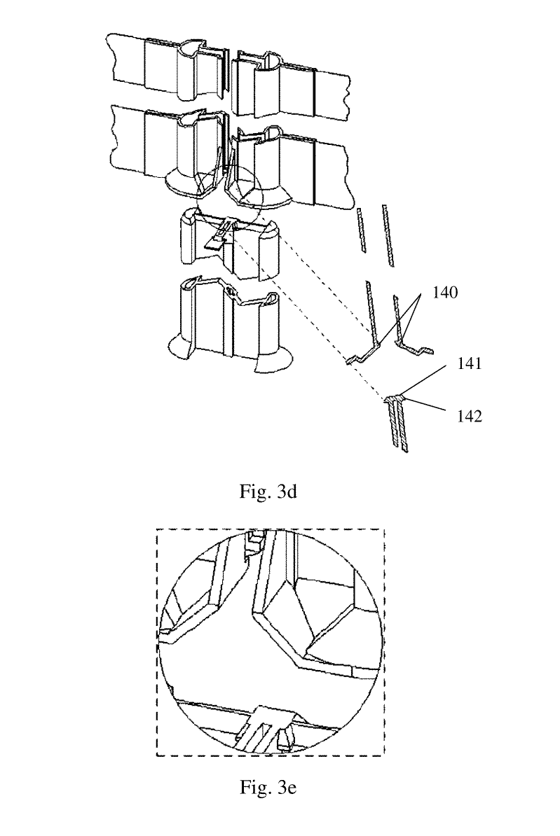

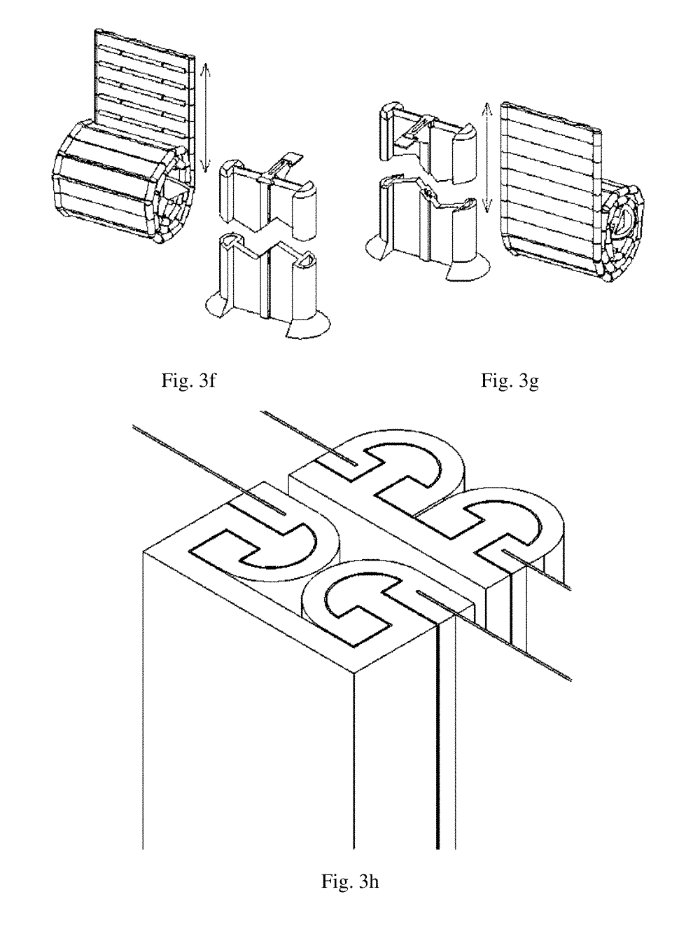

FIGS. 3a to 3h are schematic diagrams of another embodiment of the track zipper of the present disclosure. In this embodiment, the track zipper may include a first track 12, a second track 13, and a zipper core 11 for connecting the first track 12 and the second track 13. As shown in FIGS. 3c and 3d, the first track 12 and the second track 13 may be formed with some hooks 140 that can engage with an enlarged upper end 141 of the zipper core 11 so that the zipper core 11 can be stopped at a specified position. The operation of the track zipper of the present embodiment will be described with reference to the drawings. As shown in FIG. 3c, at this time the zipper core 11 is not connected to the first track 12 and the second track 13. The handle 81 is then pulled up. Since the upper end of the zipper core 11 has slanted surfaces 142, and the lower end of the first track 12 and the second track 13 is enlarged, this configuration can facilitate the insertion of the zipper core 11 into the first track 12 and the second track 13. FIG. 3b shows that the zipper core 11 has entered the first track 12 and the second track 13. When the handle 81 is pulled further upwards, the material 51 and the material 52 are connected together through the first track 12 and the second track 13, as shown in FIG. 3a. To open the track zipper, the zipper core 11 is pulled downwards. The first track 12 and the second track 13 are partially separated, as shown in FIG. 3b. If this is a zipper of a pair of trousers, then the pair of trousers can be taken off. When the handle 81 is pulled further downwards, the first track 12 and the second track 13 will be completely separated. In general, the zipper core 11 will be attached or hidden in one of the first and second tracks 12, 13. FIGS. 3f and 3g show that the portion of the zipper core 11 that is not inserted into the first track 12 and the second track 13 can be rolled up. FIG. 3h shows the structure of another track zipper. It can be seen that the openings of the track grooves on the first and second tracks can be facing any directions.

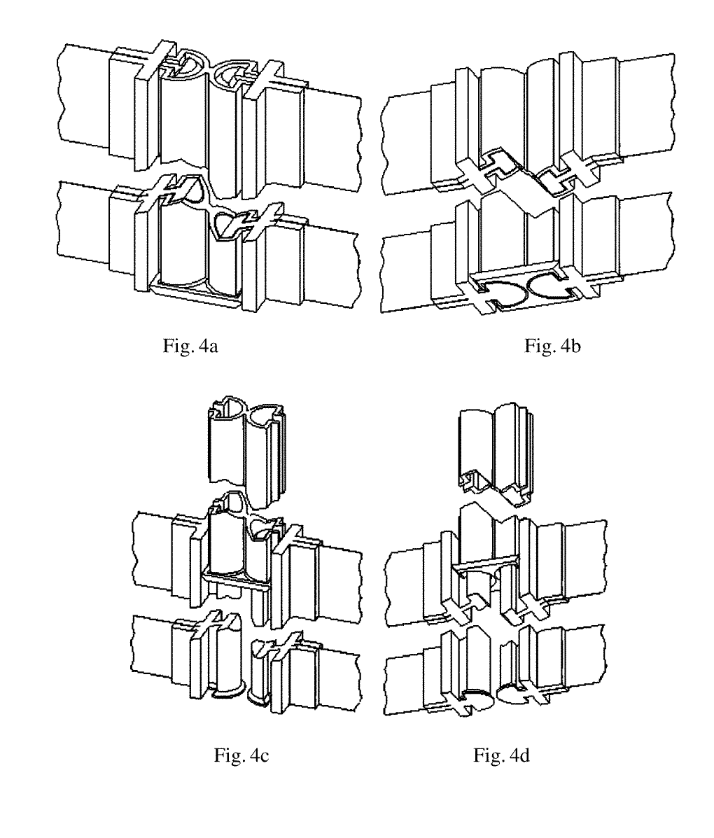

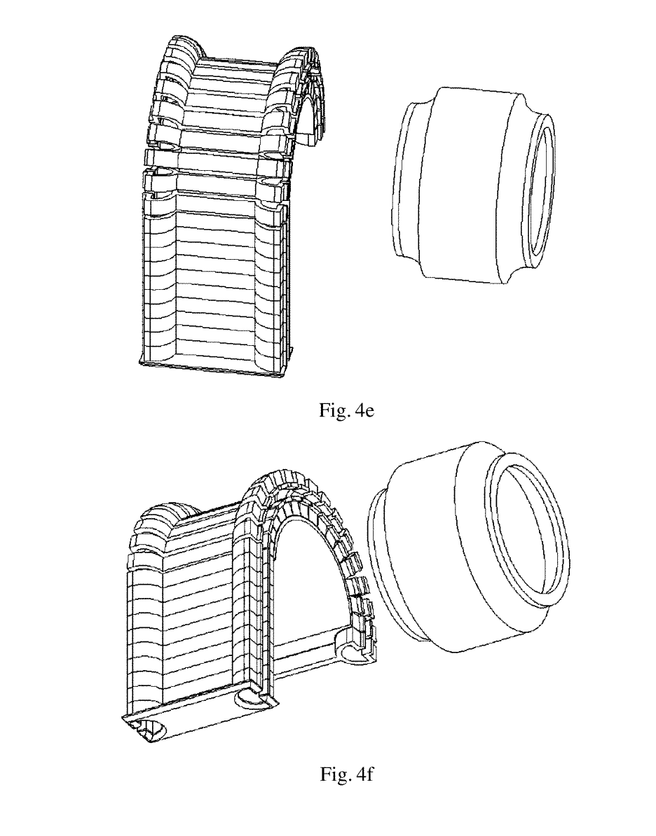

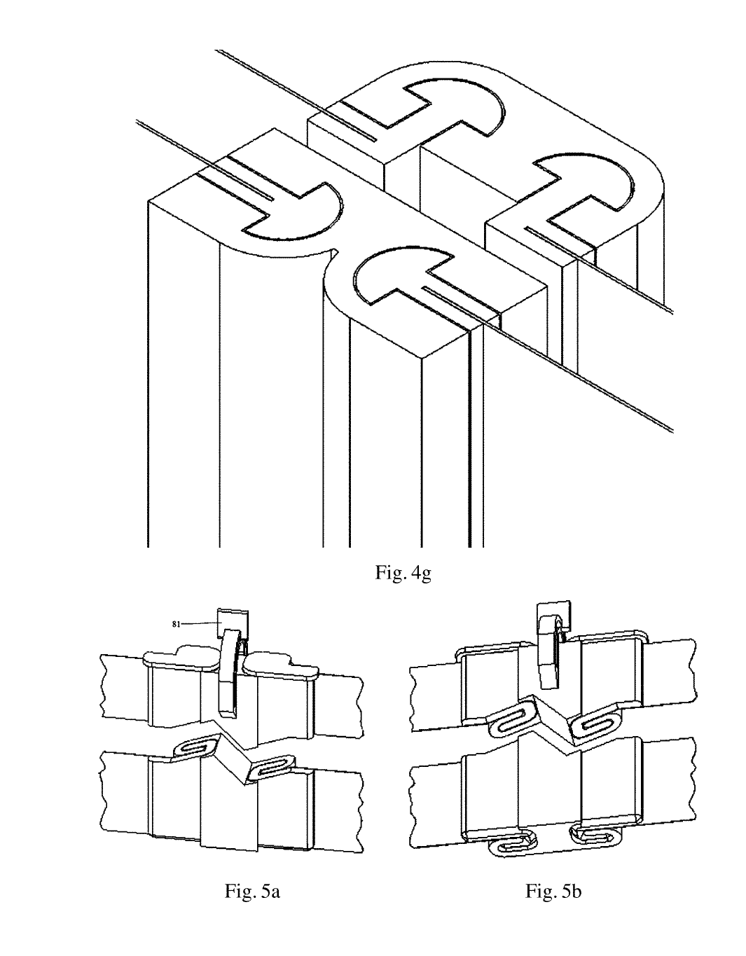

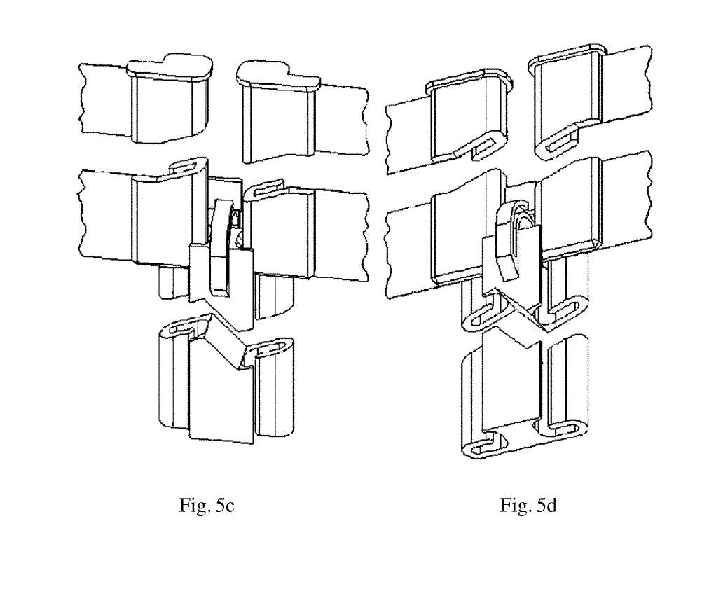

FIGS. 4a to 4g are schematic diagrams of another embodiment of the track zipper of the present disclosure. In this embodiment, the track zipper may include a first track 12, a second track 13, and a zipper core 11 connecting the first track 12 and the second track 13. The structure of the track zipper in FIGS. 4a to 4d is similar to the structure of the track zipper in FIGS. 3a to 3d. The difference is that in the track zipper shown in FIGS. 3a to 3d, the first and second track grooves are formed on the first and second tracks, and the first and second track portions are respectively formed on two sides of the zipper core; whereas in the track zipper shown in FIGS. 4a to 4d, the first and second track portions are formed on the first and second tracks, and the first and second track grooves are respectively formed on two sides of the zipper core. The portion of the zipper core that has not been inserted into the first and second tracks can be rolled up on a circular or partially circular reel or channel, as shown in FIGS. 4e and 4f. FIG. 4g shows the structure of another track zipper. It can be seen that the openings of the first and second track grooves on the zipper core can be facing any directions.

In the embodiments of several track zippers shown above, the parts of the track zipper are basically symmetric. It should be noted that this symmetrical structure is not necessary. FIGS. 5a to 5f are schematic diagrams of another embodiment of the track zipper of the present disclosure. In this embodiment, the structure of the parts of the track zipper is asymmetric. The handle on the zipper core is able to be moved to the front or rear of the zipper core, i.e. the handle can be positioned at the front or the rear of the zipper core. In FIGS. 5a and 5b, the track zipper is in a closed position, and the track portions of the zipper core are completely inserted into the corresponding track grooves of the first track and the second track. In FIGS. 5c and 5d, the track zipper is partially opened, and a portion of the track portions of the zipper core is inserted into the corresponding track grooves of the first and second tracks. In FIGS. 5e and 5f, the track zipper is in an open position, and the zipper core is detached from the first and second tracks.

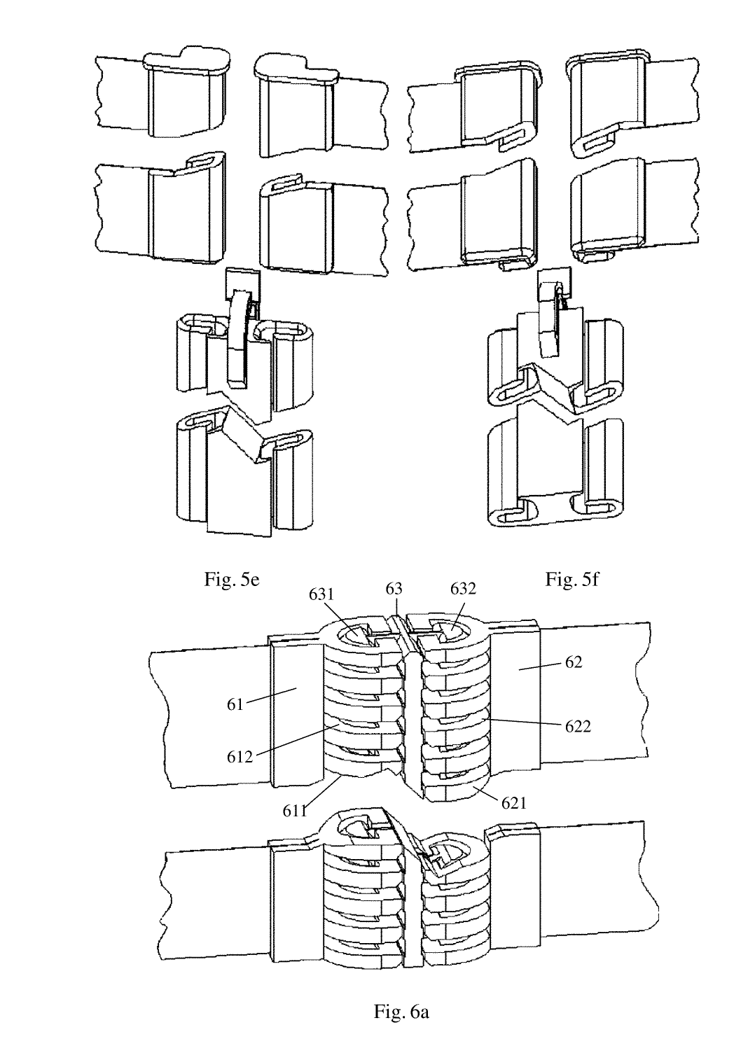

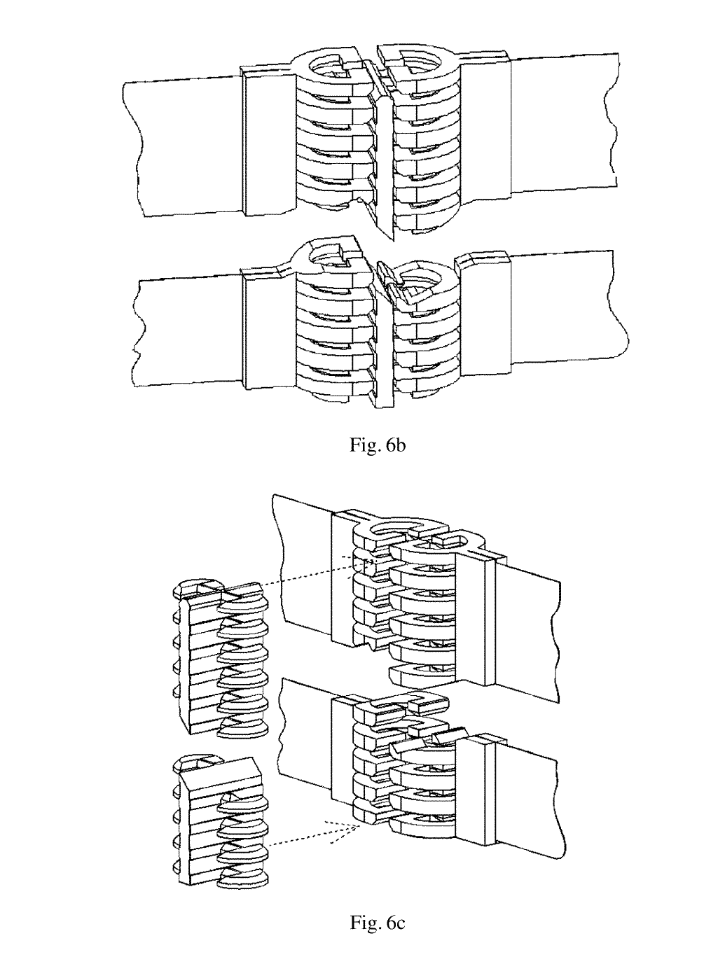

FIGS. 6a to 6c are schematic diagrams of another embodiment of the track zipper of the present disclosure. In this embodiment, in order to reduce the travel distance of the zipper core, the zipper core is configured as a segmental structure. In FIG. 6a, the track zipper is in a closed position, and the track portions of the zipper core are completely inserted into the corresponding track grooves of the first and second tracks. In FIG. 6b, the track zipper is partially opened, and the track portions of a segment of the zipper core are inserted into the corresponding track grooves of the first and second tracks. In FIG. 6c, the track zipper is in an open position, and the zipper core is detached from the first and second tracks.

As shown in FIGS. 6a to 6c, a track zipper may include a first track 61, a second track 62, and a zipper core 63 connecting the first and second tracks 61, 62. The track zipper may also include a plurality of first and second core elements 631, 632 formed along a first and second side of the zipper core 63 respectively and spaced apart in a lengthwise direction of the zipper core 63, and a plurality of first and second track elements 611, 621 formed along the first and second tracks 61, 62 respectively and spaced apart in a lengthwise direction of the first and second tracks 61, 62. A plurality of first and second slots 612, 622 may be defined by the plurality of first and second track elements 611, 621. The plurality of first and second slots 612, 622 may be dimensioned to allow the plurality of first and second core elements 631, 632 to pass therethrough in a direction perpendicular to the lengthwise direction of the first and second tracks 61, 62 respectively.

The plurality of first and second core elements 631, 632 and the plurality of first and second track elements 611, 621 may be sized and shaped so that when the track zipper is in a closed position, the plurality of first and second core elements 631, 632 can be interlocked with the plurality of first and second track elements 611, 621 respectively, and the zipper core is inseparable from the first and second tracks 61, 62 in the direction perpendicular to the lengthwise direction of the first and second tracks 61, 62.

The zipper core 63 can be slidable relative to the first and second tracks 61, 62 along the lengthwise direction thereof by a distance of one track element to a position where the plurality of first and second core elements 631, 632 can be disengaged from the plurality of first and second track elements 611, 621 respectively, so that the zipper core 63 can be detached from the first and second tracks 61, 62 in the direction perpendicular to the lengthwise direction thereof.

In one embodiment, the plurality of first and second core elements 631, 632 may be in the form of protrusions, and the plurality of first and second track elements 611, 621 may be in the form of recesses. In another embodiment, the plurality of first and second core elements 631, 632 may be in the form of recesses, and the plurality of first and second track elements 611, 621 may be in the form of protrusions. Of course, it is understood by one skilled in the art that the plurality of first and second core elements 631, 632 may be in the form of protrusions and/or recesses, and the plurality of first and second track elements 611, 621 may also be in the form of protrusions and/or recesses

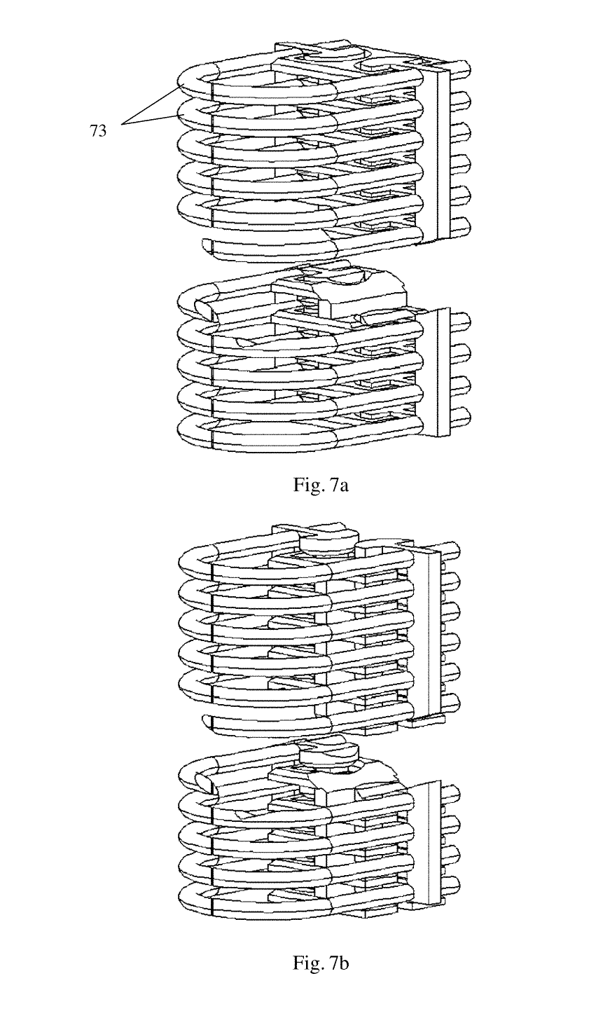

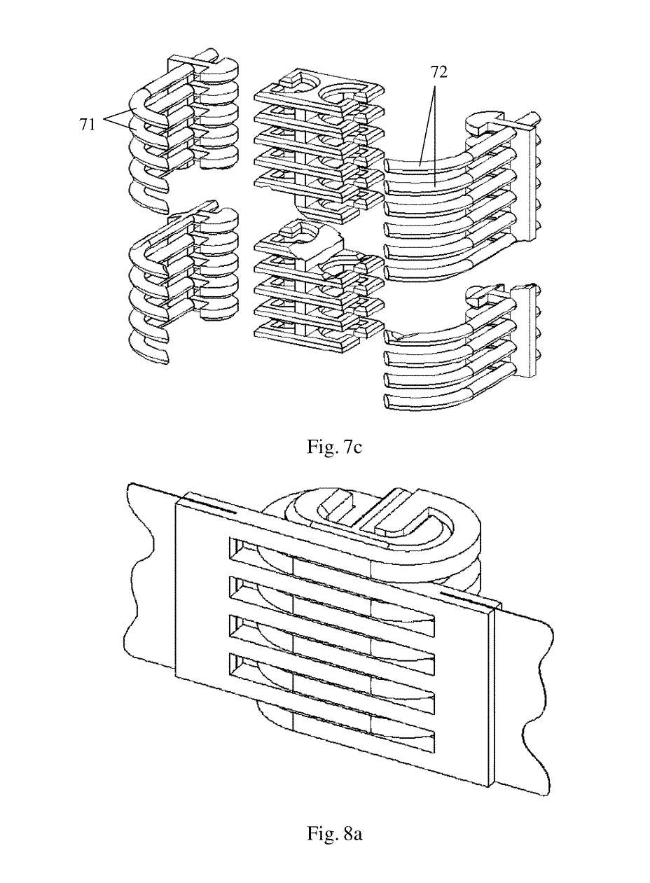

FIGS. 7a to 7c are schematic diagrams of another embodiment of the track zipper of the present disclosure. In this embodiment, the same segmental structure of the zipper core is adopted to reduce the travel distance of zipper core. In addition, some loops similar to those loose-leaf rings are provided. In FIG. 7a, the zipper core fits perfectly in the first track and the second track. In FIG. 7b, the zipper core can be moved down by one segment, and the first and second tracks in that segment are not engaged. In FIG. 7c, the zipper core is removed from the first and second tracks, and the track zipper is in an open position.

As shown in FIGS. 7a to 7c, a plurality of first and second J-shaped portions 71, 72 may be formed along the first and second tracks and spaced apart in the lengthwise direction of the first and second tracks respectively. When the track zipper is in the closed position, the plurality of first J-shaped portions 71 on the first track and the plurality of second J-shaped portions 72 on the second track may join together to form a plurality of U-shaped loops 73 extending in the direction perpendicular to the lengthwise direction of the first and second tracks, and resembling the structure of loose-leaf binding rings.

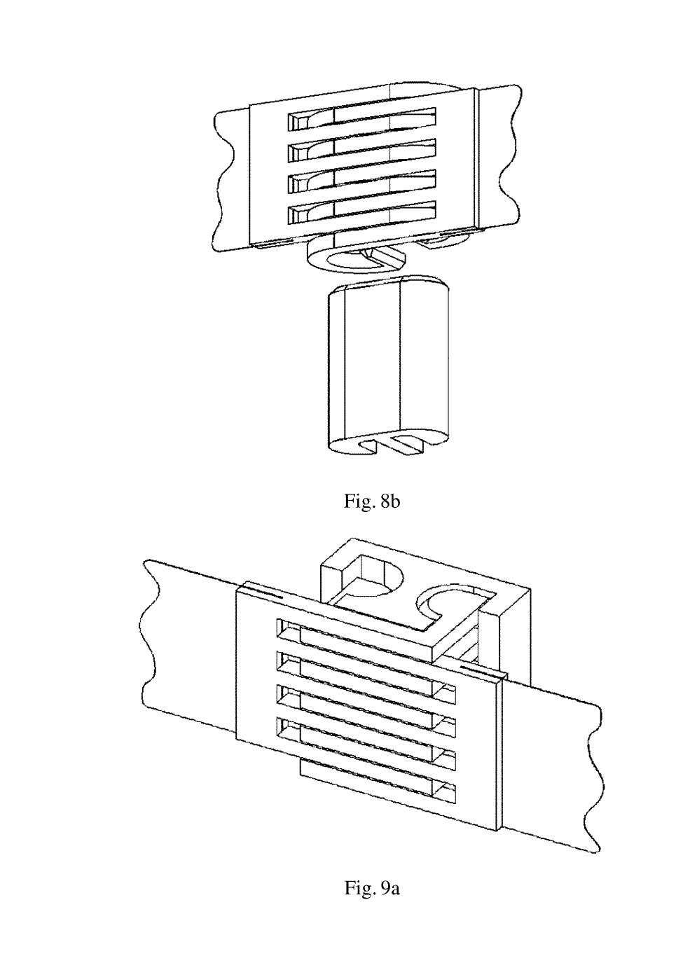

FIGS. 8a and 8b are schematic diagrams of another embodiment of the track zipper of the present disclosure. In this embodiment, the first and second tracks of the track zipper can be staggered and overlapped, and then mated with the zipper core.

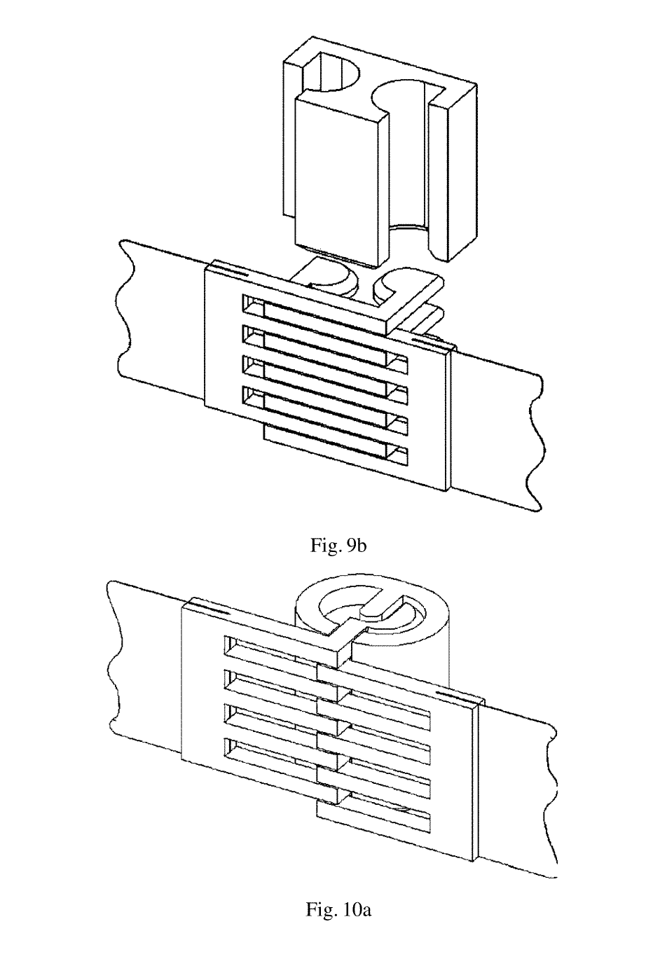

FIGS. 9a and 9b are schematic diagrams of another embodiment of the track zipper of the present disclosure. The embodiment is a modified version of the track zipper shown in FIGS. 8a and 8b. That is, the positions of the track portions and the track grooves on the zipper core, and the first and second tracks are switched.

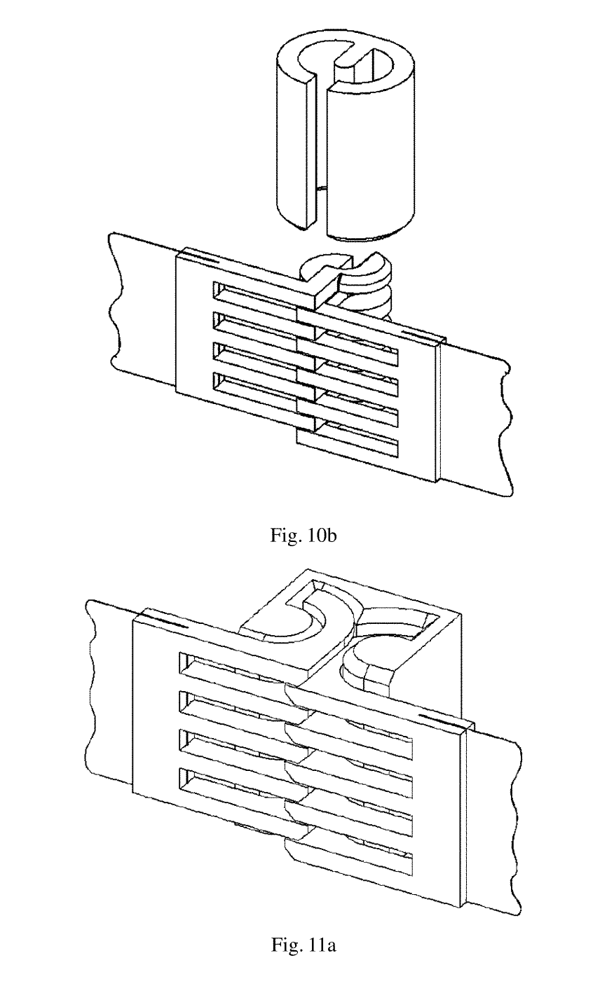

FIGS. 10a and 10b are schematic diagrams of another embodiment of the track zipper of the present disclosure. This embodiment is a modified version of the track zipper shown in FIGS. 9a and 9b. In this embodiment, the directions of the track grooves and the track portions on the zipper core, and the first and second tracks are adjusted.

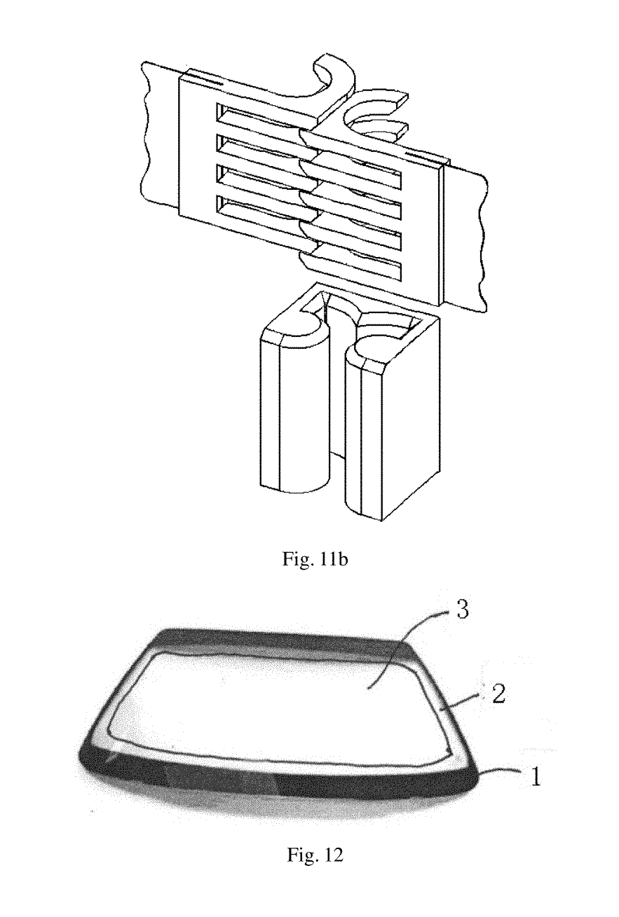

FIGS. 11a and 11b are schematic diagrams of another embodiment of the track zipper of the present disclosure. This embodiment is a modified version of the track zipper shown in FIGS. 9a and 9b. In this embodiment, the shapes of the track grooves and the track portions on the zipper core, and the first and second tracks are changed.

FIG. 12 shows an embodiment of the connecting structure with a track zipper of the present disclosure. This embodiment relates to windshield of a vehicle. It may include a windshield frame 1, a track zipper 2, and a windshield 3. The first track of the track zipper 2 may be connected with the windshield frame 1, and the second track of the track zipper 2 may be connected with the windshield 3, and the zipper core of the track zipper 2 connects the first and second tracks together. To install and change the windshield, one can simply pull the zipper core in or out of the first and second tracks. This greatly facilitates the installation and maintenance of windshields.

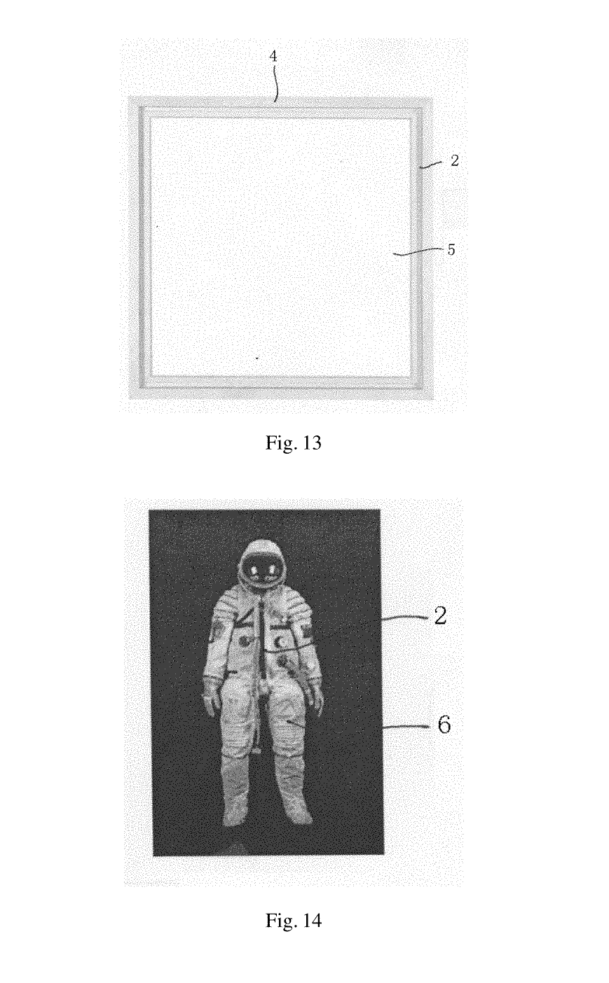

FIG. 13 shows another embodiment of the connecting structure with a track zipper of the present disclosure. This embodiment relates to a window of a building. A window glass 5 can be secured in a window frame 4 of the building by using a track zipper 2 of the present disclosure. Same as the windshield, it can facilitate the installation and replacement of window glasses.

FIG. 14 shows another embodiment of the connecting structure with a track zipper. This embodiment relates to a pressure space suit 6 capable of withstanding pressure. A track zipper 2 of the present disclosure can be installed on the pressure space suit 6.

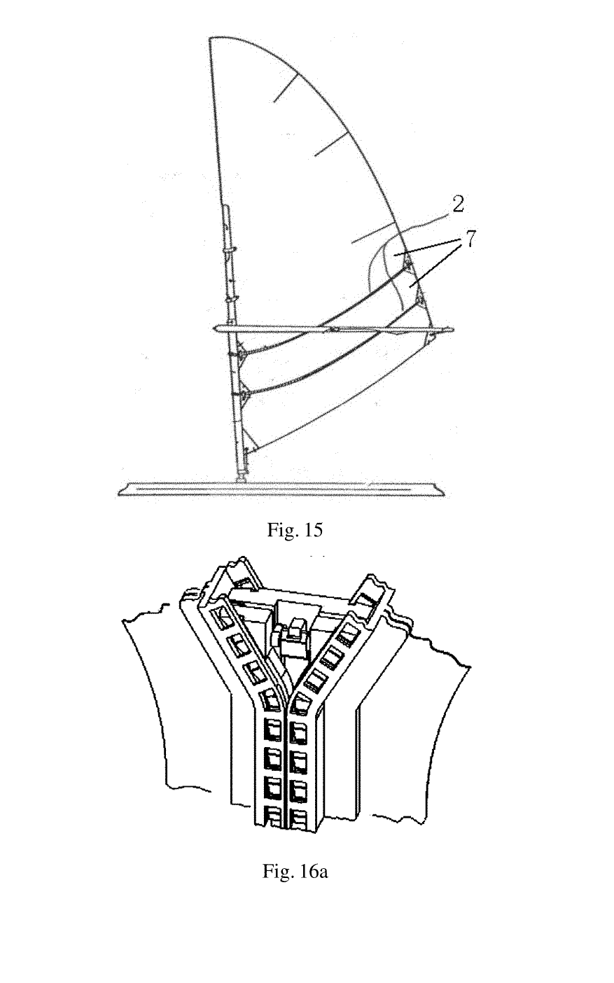

FIG. 15 shows another embodiment of the connecting structure of the present disclosure. This embodiment relates to a sail 7 of a windsurfing sailboard or a boat.

One or more the track zippers of the present disclosure may be provided on the sail 7 to connect pieces of the sail together.

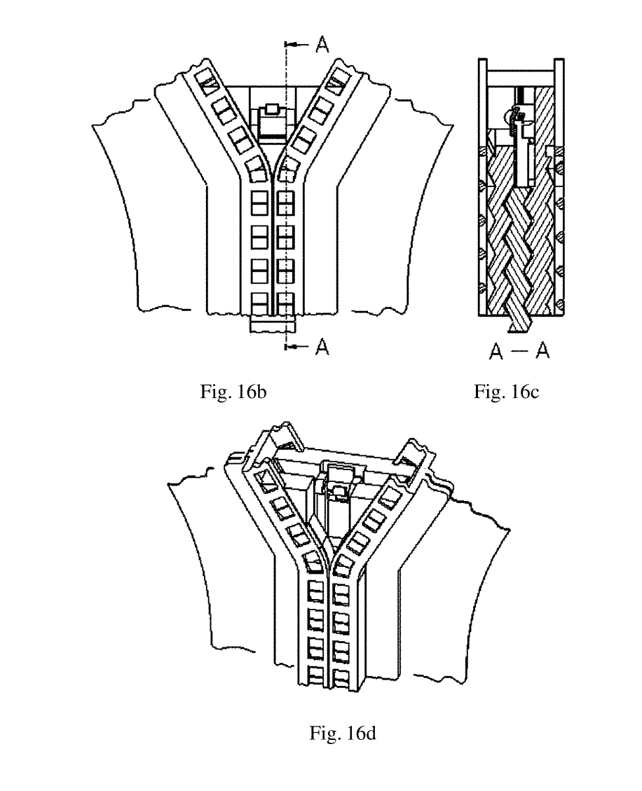

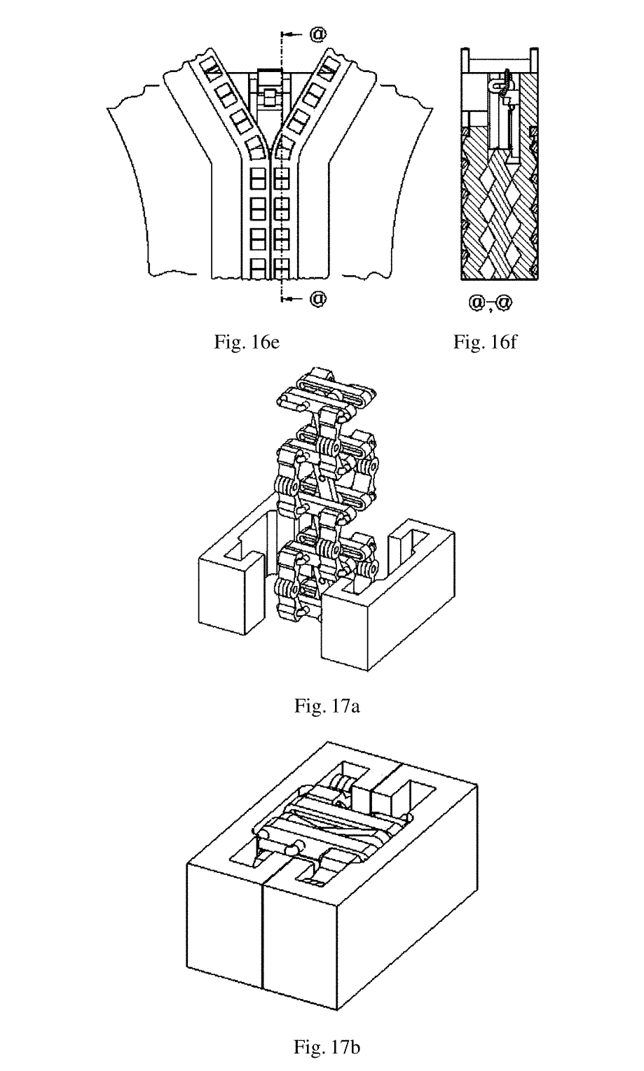

FIGS. 16a to 16f are schematic diagrams of another embodiment of the track zipper of the present disclosure. In this embodiment, the zipper core may adopt a modular core structure. The zipper core may have a three-layered structure. A middle layer can be moved up and down relative to the two outer layers. Due to the protrusion-recess structure of the layers, the thickness of the modular core can be changed. When the modular core has a maximum thickness, the protrusions of the outer layers engages with corresponding openings or grooves formed on the first and second tracks so as to close the track zipper. When the modular core has a minimum thickness, the zipper core can be pulled out from the first and second tracks to open the track zipper.

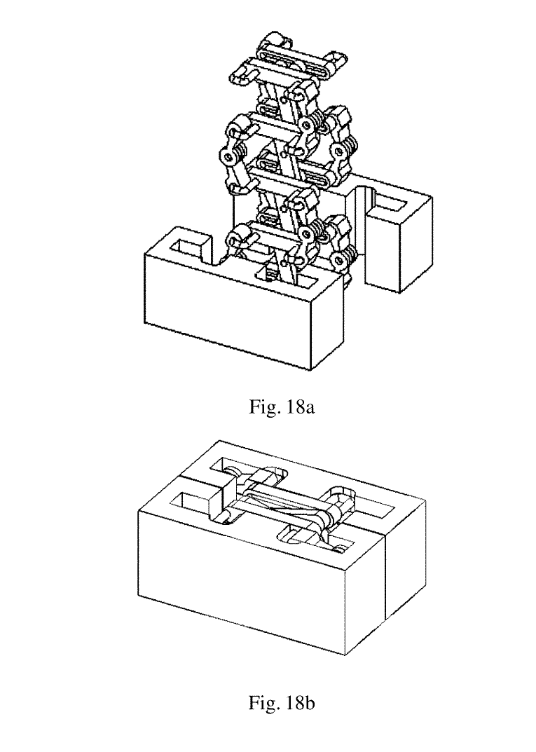

FIGS. 17a-17b and FIGS. 18a-18b are two other embodiments of the track zipper of the present disclosure. The track zipper may have a collapsible zipper core. The zipper core can be collapsed through a connecting rod structure. The zipper is opened when the zipper core is expanded, and the zipper is closed when the zipper core is collapsed.

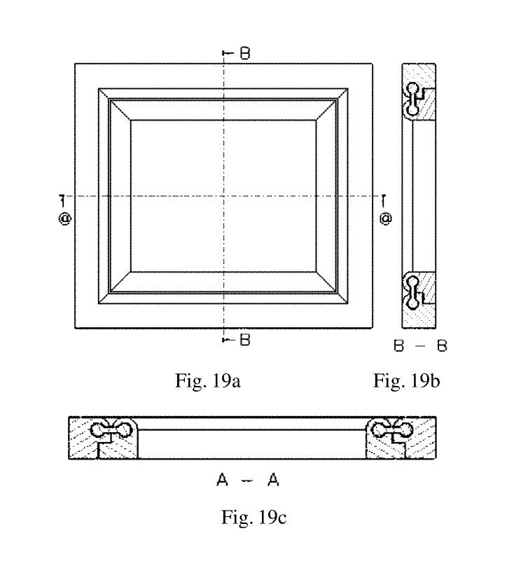

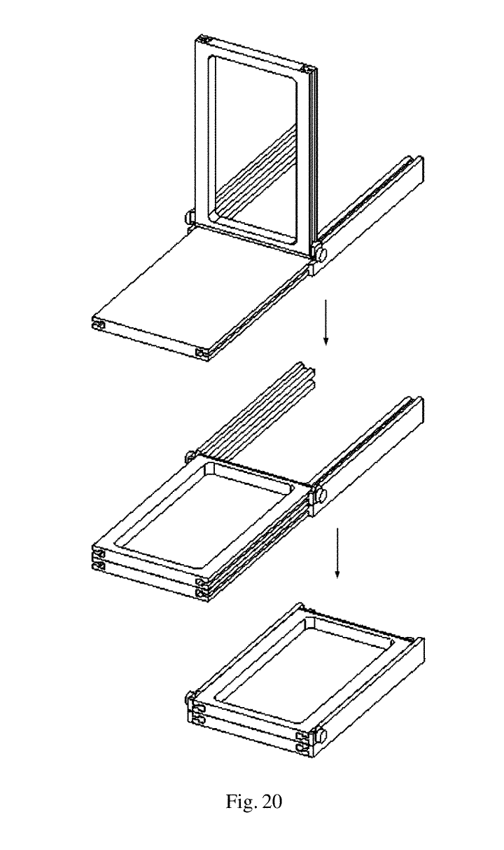

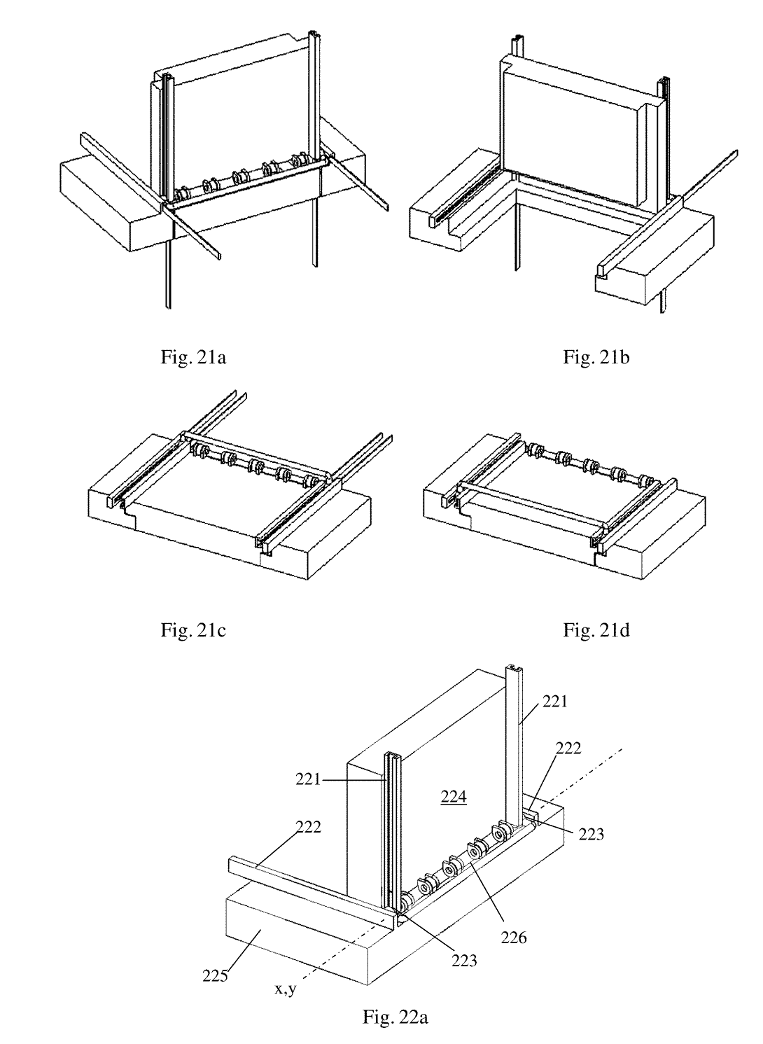

FIGS. 19a to 19c are schematic diagrams of the track zipper of the present disclosure for connecting a window to a window frame. The position of the track zippers is arbitrary, and the track zippers can be installed in any other suitable locations. FIG. 20 shows a schematic diagram of using two track zippers to connect a frame to a base plate. In the top drawing, the frame is in an open position. Since the head portions of the zipper cores are inserted into the frame and the base plate, an upper half of the head portion of each zipper core can rotate with the frame simultaneously. In the middle drawing, the frame rotates anticlockwise until it rests on top of the base plate. In the bottom drawing, the track zippers are closed, and the frame cannot be opened.

FIGS. 21a to 21d are schematic diagrams of the track zipper of the present disclosure used for connecting a door or a cover. In this embodiment, a movable part can be connected to a stationary part. It can be used for doors and covers, including hatch doors, and a variety of doors and covers in a house. When the zipper is closed, the door cannot be opened. FIGS. 21a and 21b are different views of the same structure.

As shown in FIG. 21c, the middle portion (i.e., the door or cover) can be rotated anticlockwise until it is closed. As shown in FIG. 21d the two zipper cores are pulled forwards so that the door or cover cannot be opened. In order to pre-install the zipper cores in the channels, each zipper core can be split or combined, and can be rotated.

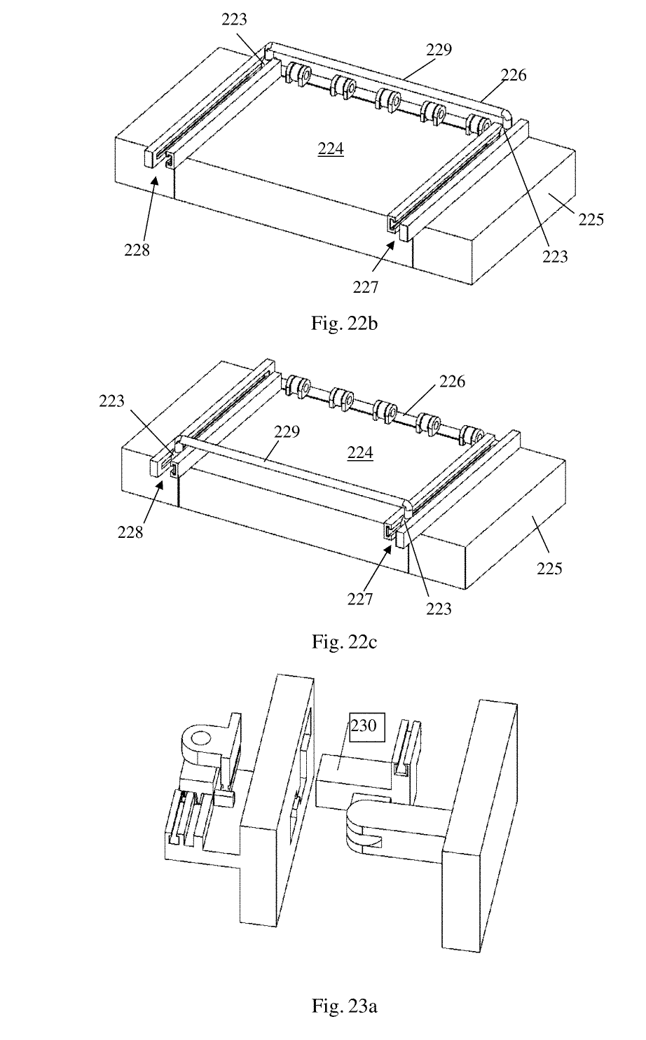

FIGS. 22a-22c are the same as FIGS. 21a-21d, except that the zipper cores are shortened or concealed.

As shown in FIGS. 22a-22c, each track zipper 227, 228 may include a first track 221, a second track 222, and a zipper core 223 connecting the first and second tracks 221, 222. A first slidably connecting structure may be provided on the first track 221 and a first side of the zipper core 223. The zipper core 223 can be slidable relative to the first track 221 along a lengthwise direction thereof, and the zipper core 223 is inseparable from the first track 221 in a direction perpendicular to the lengthwise direction of the first track. Similarly, a second slidably connecting structure may be provided on the second track 222 and a second side of the zipper core 223. The zipper core 223 can be slidable relative to the second track 222 along a lengthwise direction thereof, and the zipper core 223 is inseparable from the second track 222 in a direction perpendicular to the lengthwise direction of the second track. When the track zipper is in an open position, the first and second tracks 221, 222 may be disposed at an angle with respect to each other, and the zipper core 223 may be located at one ends of the first and second tracks 221, 222 where the angle is formed. When the track zipper is in a closed position, the first and second tracks 221, 222 may be parallel to each other, and the zipper core 223 can be slidable to a position away from the one ends of the first and second tracks 221, 222, thereby closing the track zipper. The first track 221, the second track 222, and the zipper core 223 may be made of a rigid material, such as wood, hard plastic, metal, or any other rigid materials.

In another aspect, a connecting structure with track zippers 227, 228 may be provided. The connecting structure may include a first rigid object 224, a second rigid object 225 hingedly connected to the first rigid object 224 by a hinge 226, and a first and second track zipper 227, 228 as described above for connecting the first and second rigid objects 224, 225. The first track 221 of the first track zipper 227 and the first track 221 of the second track zipper 228 may be respectively attached along two side portions of the first rigid object 224 adjacent to the hinge 226, and the second track 222 of the first track zipper 227 and the second track 222 of the second track zipper 228 may be respectively attached along two side portions of the second rigid object 225 adjacent to the hinge 226.

When the first and second track zippers 227, 228 are in an open position, the first and second tracks 221, 222 of each track zipper can be disposed at an angle with respect to each other. The first and second zipper cores 223 may be located at one ends of the first and second tracks 221, 222 of the first and second track zippers 227, 228 respectively along a zipper core axis x passing through the zipper cores 223 and coincident with a hinge axis y of the hinge 226. The first and second zipper cores 223 can be slidable together along the first and second tracks 221, 222 of the first and second track zippers 227, 228 respectively in a direction away from the hinge 226, thereby closing the first and second track zippers 227, 228. The connecting structure may further include a cross bar 229 having a first end connected to the first zipper core 223, and a second end connected to the second zipper core 223.

The zipper cores 223 can be connected to the first and second tracks 221, 222 at all times. On the other hand, the zipper cores 223 can be detached from the first and second tracks 221, 222, and can be inserted back into the first and second tracks 221, 222, preferably through lead-in. The track zippers 227, 228 may be kept in the closed position because they are so arranged that the track zippers 2287, 228 cannot be opened when the zipper cores 223 are moved away from the hinge 226. It is understood that the zipper cores 223 need not be moved to the other ends of the first and second tracks 221, 222. The zipper cores 223 can keep the track zippers 227, 228 close as long as they are far enough from the hinge 226. Each of the zipper cores 223 can be a one-piece structure, like a dumbbell, or it can be a two-piece structure connecting like a pair of scissors.

The connecting structure of the present disclosure can have a wide range of applications. For example, in the connecting structure, the first rigid object can be a door and the second rigid object can be a door frame, wherein the door is closed when the first and second track zippers are in the closed position. The first rigid object can be a cover and the second rigid object can be a frame for the cover, wherein the cover is closed when the first and second track zippers are in the closed position. The first rigid object can be a first panel of a piece of furniture and the second rigid object can be a second panel of the piece of furniture, wherein the first and second panels can be secured together when the first and second track zippers are in the closed position. The first and second rigid objects can be a casing of a reusable cable tie, wherein the casing can be folded up to secure therein a tape section of the reusable cable tie when the first and second track zippers are in the closed position. The first and second rigid objects can also be parts of a device for adjusting opening angle of a window.

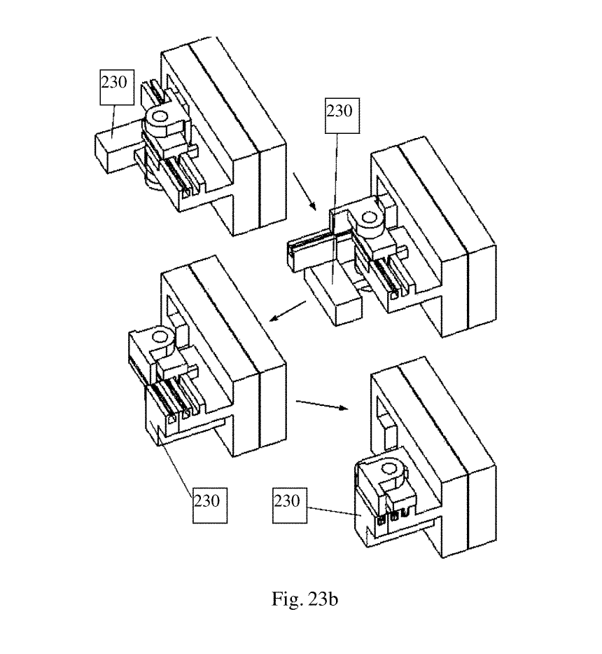

FIGS. 23a and 23b are schematic diagrams of the track zipper of the present disclosure used for the connection of a movable part and a stationary part. The right assembly on the right side of FIG. 23a penetrates into the left assembly on the left side of FIG. 23a, and can then form into the assembly shown in the first drawing in FIG. 23b. After two 90 degree rotations, the assembly becomes the assembly shown in the third drawings in FIG. 23b. The last drawing in FIG. 23b shows the assembly after pulling of the zipper core. Before the track zipper is opened, an abutment 230 of the right assembly continues to abut against the left assembly.

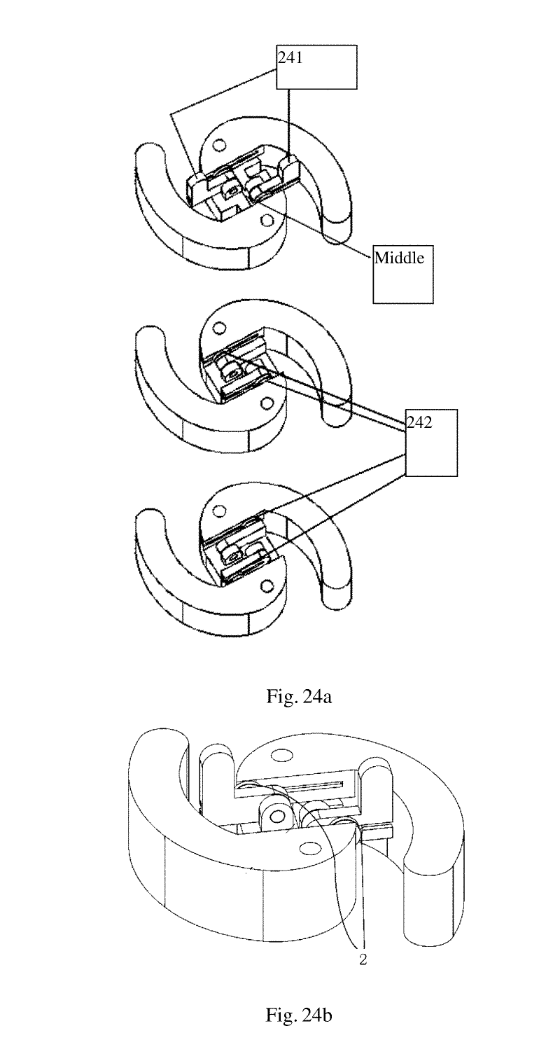

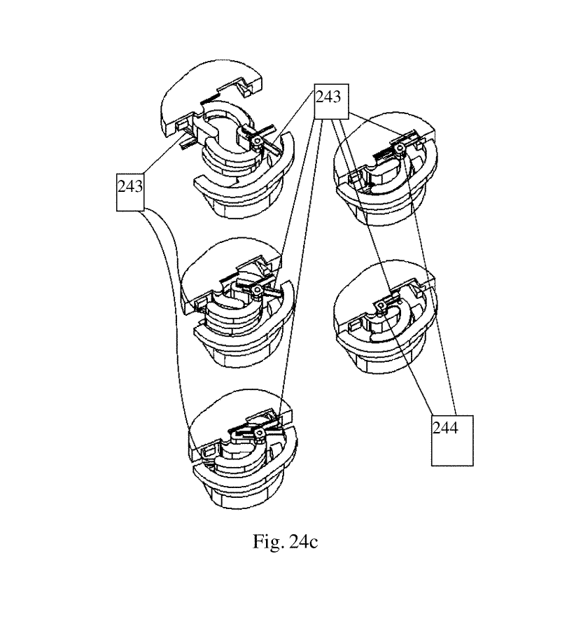

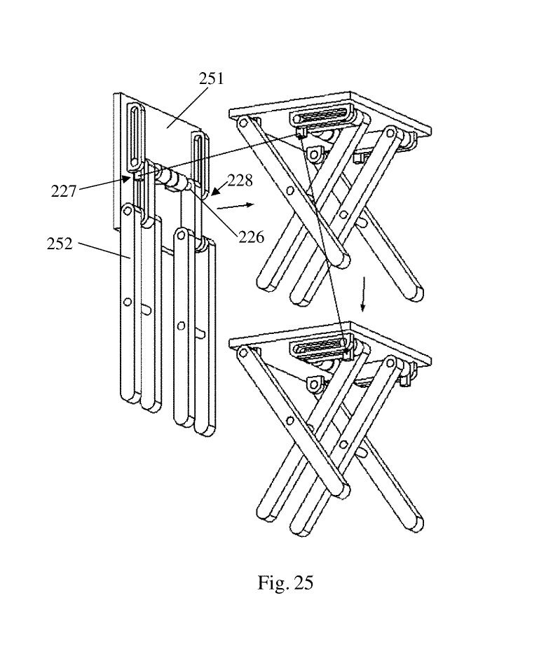

FIGS. 24a to 24c are schematic diagrams of the track zipper of the present disclosure for use in automatic connection hooks. Similar to the design of automatic hooks for train cars, when two train cars approach towards each other, two hooks will turn into an “S” combination. At this time, two “7” shaped hooks 241, as best illustrated in the top drawing of FIG. 24a, can be rotated 180 degrees to clasp onto each other, as shown in the middle drawing of FIG. 24a. After two track zippers 242 are closed, the “S” combination will be inseparable. When the track zippers 242 are pulled to the position shown in FIG. 24b, the two “7” shaped hooks cannot be rotated. FIG. 24c shows a design similar to the design of automatic hooks for train cars. The three drawings on the left side of FIG. 24c show the automatic hooks when two train cars are approaching. The upper drawing on the right side of FIG. 24c shows the hooks when the two train cars are stopped. The lower drawing on the right side of FIG. 24c shows the hooks after zipper cores 243 of track zippers 244 are pulled into the stationary parts on the other sides. The hooks are then inseparable.

FIG. 25 is a schematic diagram of the track zipper for use in a foldable chair. After the foldable chair is unfolded and the track zippers are pulled to a closed position, the unfolded chair cannot be folded up.

As shown in FIG. 25, in the connecting structure, the first rigid object can be a seat 251 of a foldable chair and the second rigid object can be a pair of crossed legs 252 of the foldable chair, wherein the seat 251 and the pair of crossed legs 252 can be secured together and the foldable chair is unfolded when the first and second tracks 227, 228 are in the closed position. When the hinge 226 is moved to the closed position, as shown in the lower right drawing of FIG. 25, the foldable chair cannot be folded so that a user sitting on it will not fall.

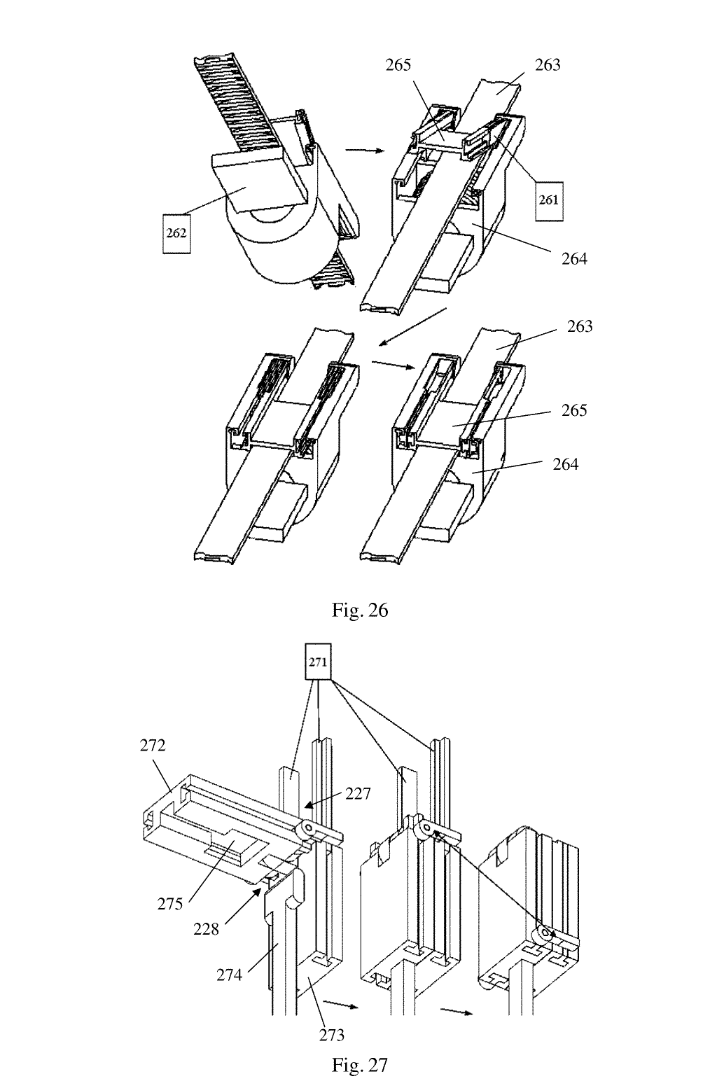

FIG. 26 is a schematic diagram of the track zipper of the present disclosure for use in a hose clamp. The hose clamp can be a reusable hose clamp. The top two drawing are different views of the same hose clamp. When the track zippers are in an open position, a serrated band 263 can be moved along the direction of the casing, i.e. first casing 264 and second casing 265. The first and second casings may be moveable between an upfold position and a fold up position. After the serrated band is adjusted to a desired position, the serrated band will be locked by folding up the first and second casings. As shown in the bottom drawing on the left side of FIG. 26, the track zippers are in an open position. The track zippers can be closed by pulling zipper cores 261 into the corresponding tracks, as shown in the bottom drawing on the right side of FIG. 26. It is still possible to adjust its tightness by rotating a knob 262. This structure can be used in a wide range of applications, such as a reusable cable tie. It can also be used to adjust the angle of an aluminum window.

As shown in FIG. 26, in the connecting structure, the first and second rigid objects can be a casing 264, 265 of a hose clamp, wherein the casing 264, 265 can be folded up to secure therein a serrated band 263 of the hose clamp when the first and second track zippers are in the closed position.

FIG. 27 is a schematic diagram of the track zipper of the present disclosure for use in a lock. The left drawing in FIG. 27 shows an opened cover. A “T” shaped object is put in a set position. The middle drawing shows that the cover is closed up. The right drawing shows that zipper cores 271 are pulled inside corresponding tracks so that the cover cannot be opened and the “T” shaped object is locked. This concept can be used for various types of locking mechanism. For example, a watch case can be locked onto a watch strap without providing watch lugs on the watch case.

As shown in FIG. 27, the first and second rigid objects can a casing of a lock. The casing may include a cover 272 and a base 273. The casing can be folded up to secure a T-shaped object 274 in a T-shaped trough 275 in the casing when the first and second track zippers 227, 228 are in the closed position.

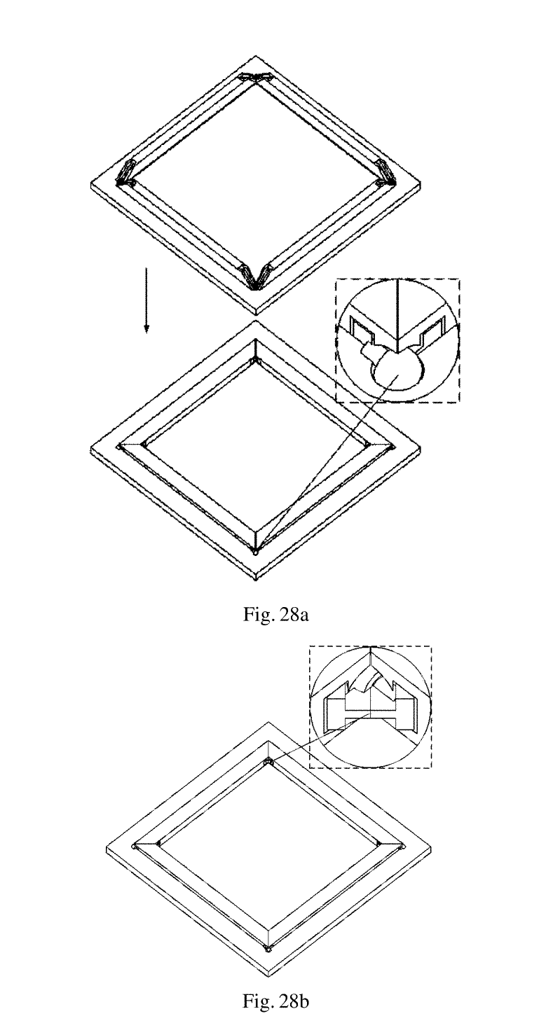

FIGS. 28a to 28b are schematic diagrams of the track zipper of the present disclosure for use in a picture frame or a mirror frame. The top drawing in FIG. 28a shows that a frame is in an open position, and the bottom drawing in FIG. 28a shows that the frame is in a closed position. If a picture or a mirror is placed in the frame, it will be pressed. The enlarged view shows that a universal hinge may be provided at each of the four corners of the frame. As shown in FIG. 28b, when the track zippers at the four corners of the frame are pulled inwards, the frame cannot be opened. A line/rope/belt/cable may be provided, or a space for a handle may be provided to facilitate the completion of the action. It should be noted that the universal hinges are not necessary. Instead, ordinary hinges can be used. The only requirement is that these hinges need to be deeply hidden and attention should be paid when turning from vertical to horizontal position.

Specific embodiments have been described above with reference to the accompanying drawings. However, the present disclosure is not limited to the above specific embodiments. The above specific embodiments are merely illustrative and should not be considered as limiting. It should be noted that, upon reading the above disclosure, a person skilled in the art can make various other changes or modifications without departing from the scope of the appended claims.

What is claimed is:

1. A track zipper comprising:
a first track;
a second track;
a zipper core connecting the first and second tracks;
a plurality of first and second core elements formed along a first and second side of the zipper core respectively and spaced apart in a lengthwise direction of the zipper core;
a plurality of first and second track elements formed along the first and second tracks respectively and spaced apart in a lengthwise direction of the first and second tracks; and
a plurality of first and second slots defined by the plurality of first and second track elements, the plurality of first and second slots are dimensioned to allow the plurality of first and second core elements to pass therethrough in a direction perpendicular to the lengthwise direction of the first and second tracks respectively,
wherein the plurality of first and second core elements and the plurality of first and second track elements are sized and shaped so that when the track zipper is in a closed position, the plurality of first and second core elements are interlocked with the plurality of first and second track elements respectively, and the zipper core is inseparable from the first and second tracks in the direction perpendicular to the lengthwise direction of the first and second tracks, and
wherein the zipper core is slidable relative to the first and second tracks along the lengthwise direction thereof by a distance of one track element to a position where the plurality of first and second core elements are disengaged from the plurality of first and second track elements respectively, so that the zipper core is detachable from the first and second tracks in the direction perpendicular to the lengthwise direction thereof.

2. The track zipper according to claim 1, wherein the plurality of first and second core elements are in the form of protrusions, and the plurality of first and second track elements are in the form of recesses.

3. The track zipper according to claim 1, wherein the plurality of first and second core elements are in the form of recesses, and the plurality of first and second track elements are in the form of protrusions.

4. A track zipper comprising:
a first track;
a second track;
a zipper core connecting the first and second tracks;
a first slidably connecting structure provided on the first track and a first side of the zipper core, the zipper core being slidable relative to the first track along a lengthwise direction thereof, and the zipper core being inseparable from the first track in a direction perpendicular to the lengthwise direction of the first track;
a second slidably connecting structure provided on the second track and a second side of the zipper core, the zipper core being slidable relative to the second track along a lengthwise direction thereof, and the zipper core being inseparable from the second track in a direction perpendicular to the lengthwise direction of the second track;
a front plurality of first and second zipper teeth formed along the first and second tracks respectively and disposed at a front side of the zipper core;
a rear plurality of first and second zipper teeth formed along the first and second tracks respectively and disposed at a rear side of the zipper core; and
a zipper head formed at an upper end of the zipper core, the zipper head comprising a front and rear Y-shaped channel provided on the front side and the rear side of the zipper core respectively, the front and rear Y-shaped channels being defined by a top wedge and two sidewalls, the front and rear Y-shaped channels dimensioned to allow the front and rear plurality of first and second zipper teeth to pass through in a manner of a conventional zipper.

5. The track zipper according to claim 4, further comprising
an upper guiding portion formed at an upper portion of each sidewall; and
a lower guiding portion in the form of a protrusion formed on an inner side of each sidewall at a position where the front and rear plurality of first and second zipper teeth interlock and disengage,
wherein when the zipper head together with the zipper core is pulled upwards, the lower guiding portions press the front and rear plurality of first and second zipper teeth together so that the front and rear plurality of first and second zipper teeth are interlocked with each other, thereby closing the track zipper, and
when the zipper head together with the zipper core is pulled downwards, the wedge and the upper guiding portions push the front and rear plurality of first and second zipper teeth apart so that the front and rear plurality of first and second zipper teeth are disengaged from each other, thereby opening the track zipper.

6. The track zipper according to claim 4, further comprising
an outwardly extending projection formed at a free end of each zipper teeth, the outwardly extending projections of one of the first and second tracks are insertable into corresponding inwardly facing slots of the other one of the first and second tracks;
an outwardly extending guiding portion formed on a front surface and a rear surface of the zipper core at a position where the front and rear plurality of first and second zipper teeth interlock and disengage; and
an inwardly extending guiding portion formed on the front side and the rear side of the zipper core, and disposed above and spaced outwardly apart from the outwardly extending guiding portion,
wherein when the zipper head together with the zipper core is pulled upwards, the outwardly extending guiding portions press the front and rear plurality of first and second zipper teeth outwards, the outwardly extending projections of the front and rear plurality of first and second zipper teeth are inserted into the corresponding inwardly facing slots, and the front and rear plurality of first and second zipper teeth are interlocked with each other, thereby closing the track zipper, and
when the zipper head together with the zipper core is pulled downwards, the wedge pushes the front and rear plurality of first and second zipper teeth apart, the inwardly extending guiding portions press the front and rear plurality of first and second zipper teeth inwards, the outwardly extending projections of the front and rear plurality of first and second zipper teeth are released from the corresponding inwardly facing slots, and the front and rear plurality of first and second zipper teeth can be disengaged from each other, thereby opening the track zipper.

7. A track zipper comprising:
a first track;
a second track;
a zipper core connecting the first and second tracks;
a first slidably connecting structure provided on the first track and a first side of the zipper core, the zipper core being slidable relative to the first track along a lengthwise direction thereof, and the zipper core being inseparable from the first track in a direction perpendicular to the lengthwise direction of the first track; and
a second slidably connecting structure provided on the second track and a second side of the zipper core, the zipper core being slidable relative to the second track along a lengthwise direction thereof, and the zipper core being inseparable from the second track in a direction perpendicular to the lengthwise direction of the second track,
wherein when the track zipper is in an open position, the first and second tracks are disposed at an angle with respect to each other, and the zipper core is located at one ends of the first and second tracks where the angle is formed, and when the track zipper is in a closed position, the first and second tracks are parallel to each other, and the zipper core is slidable to a position away from the one ends of the first and second tracks, thereby closing the track zipper,
wherein the first track, the second track, and the zipper core are made of a rigid material.

8. The track zipper according to claim 7, wherein the first slidably connecting structure comprises a first track groove formed on the first track; and a first track portion formed on the first side of the zipper core and mating with the first track groove, the first track portion of the zipper core being sheathed in the first track groove and slidable in the first track groove along an extending direction thereof, and inseparable from the first track groove in a direction perpendicular to the extending direction of the first track groove.

9. The track zipper according to claim 7, wherein the first slidably connecting structure comprises a first track portion formed on the first track; and a first track groove formed on the first side of the zipper core and mating with the first track portion, the first track groove of the zipper core being sheathed on the first track portion, the first track groove being slidable on the first track portion along an extending direction thereof, and inseparable from the first track portion in a direction perpendicular to the extending direction of the first track portion.

10. The track zipper according to claim 7, wherein the second slidably connecting structure comprises a second track groove formed on the second track; and a second track portion formed on the second side of the zipper core and mating with the second track groove, the second track portion of the zipper core being sheathed in the second track groove and slidable in the second track groove along an extending direction thereof, and inseparable from the second track groove in a direction perpendicular to the extending direction of the second track groove.

11. The track zipper according to claim 7, wherein the second slidably connecting structure comprises a second track portion formed on the second track; and a second track groove formed on the second side of the zipper core and mating with the second track portion, the second track groove of the zipper core being sheathed on the second track portion, the second track groove being slidable on the second track portion along an extending direction thereof, and inseparable from the second track portion in a direction perpendicular to the extending direction of the second track portion.

12. A connecting structure comprising:
a first rigid object;
a second rigid object hingedly connected to the first rigid object by a hinge; and
a first and second track zipper, each being as claimed in claim 7, for connecting the first and second rigid objects,
wherein one of the first and second tracks of the first track zipper and one of the first and second tracks of the second track zipper are respectively attached along two side portions of the first rigid object adjacent to the hinge, and another one of the first and second tracks of the first track zipper and another one of the first and second tracks of the second track zipper are respectively attached along two side portions of the second rigid object adjacent to the hinge,
wherein when the first and second track zippers are in an open position, the first and second tracks of each track zipper are disposed at an angle with respect to each other, the zipper cores are located at one ends of the first and second tracks of the first and second track zippers respectively along a zipper core axis passing through the zipper cores and coincident with a hinge axis of the hinge, and
wherein the zipper cores are slidable together along the first and second tracks of the first and second track zippers respectively in a direction away from the hinge, thereby closing the first and second track zippers.

13. The connecting structure according to claim 12, further comprising a cross bar having a first end connected to the first zipper core of the first track zipper, and a second end connected to the second zipper core of the second track zipper.

14. The connecting structure according to claim 12, wherein the first rigid object is a door and the second rigid object is a door frame, wherein the door is closed when the first and second track zippers are in the closed position.

15. The connecting structure according to claim 12, wherein the first rigid object is a cover and the second rigid object is a frame for the cover, wherein the cover is closed when the first and second track zippers are in the closed position.

16. The connecting structure according to claim 12, wherein the first rigid object is a first panel of a piece of furniture and the second rigid object is a second panel of the piece of furniture, wherein the first and second panels are secured together when the first and second track zippers are in the closed position.

17. The connecting structure according to claim 12, wherein the first rigid object is a seat of a foldable chair and the second rigid object is a pair of crossed legs of the foldable chair, wherein the seat and the pair of crossed legs are secured together when the first and second track zippers are in the closed position.

18. The connecting structure according to claim 12, wherein the first and second rigid objects are a casing of a lock, wherein the casing is folded up to secure a T-shaped object in a T-shaped trough in the casing when the first and second track zippers are in the closed position.

19. The connecting structure according to claim 12, wherein the first and second rigid objects are a casing of a hose clamp or a reusable cable tie, wherein the casing is folded up to secure therein a serrated band attached to the casing when the first and second track zippers are in the closed position.

20. The connecting structure according to claim 12, wherein the first and second rigid objects are parts of a device for adjusting opening angle of a window.
